(19) United States
(12) Patent Application Publication
(10) Pub. No.: US 2007/0288440 A1
(43) Pub. Date: Dec. 13, 2007

(54) Method and system for operating a web based service

(76) Inventors: Albert Lewis Harlow, Chagrin Falls, OH (US); Mark Wayne Matta, Jacksonville, FL (US); Valerie Lee Matta, Jacksonville, FL (US)

Correspondence Address: FAY SHARPE LLP, 1100 SUPERIOR AVENUE, SEVENTH FLOOR, CLEVELAND, OH, 44114, US

(21) Appl. No.: 11/803,479

(22) Filed: May 15, 2007

Related U.S. Application Data
(63) Continuation-in-part of application No. 11/298,791, filed on Dec. 9, 2005.
(60) Provisional application No. 60/634,618, filed on Dec. 9, 2004.

(51) Int. Cl. G06F 7/00; G06F 17/00

(52) U.S. Cl. 707/3; 707/E17.108

(57) ABSTRACT

A web based services to (1) create and manage contact information, (2) create and deliver mail pieces, (3) retrieve and compile contacts specifically tailored to user selected attributes, and (4) search the web for available jobs tailored to user provided search criteria is disclosed. The contact information is integrated with a web based literature creation and direct mailing service. A subscriber accesses the home page of the web based system by using a computer with an electronic connection to the appropriate server. After a subscriber is successfully logged in, the subscriber can access a jobs search module, a contacts manager module, a documents module, and a job campaigns module to search for available jobs, compile a list of company contacts, create resumes/cover letters, and conduct a job campaign which integrates the results of the job search, compiled company contacts and created resumes/cover letters.

This application is a continuation-in-part and claims priority to and the benefit of U.S. patent application Ser. No. 11/298,791, filed Dec. 9, 2005, which claims priority to U.S. Provisional Application No. 60/634,618, filed Dec. 9, 2004, which applications are incorporated herein by reference in their entirety.

### BACKGROUND OF THE INVENTION

The present invention relates to (1) web based services to create and manage contact information, (2) web based services to create and deliver direct-mail pieces, (3) web based services to access, retrieve and compile contacts specifically tailored to user selected attributes, and (4) web based services to search the web for available jobs tailored to user provided search criteria.

Currently, job seekers prepare resumes or have them prepared. Paper copies of the resumes are placed in an envelope, addressed to a contact or a prospective company and mailed. To reach a wider audience, some job seekers subscribe to a mailing list service that supply mailing labels to the personnel manager or other generic recipient of companies in selected fields.

Other job seekers post resumes on web sites to be viewed by potential employees. Some e-mail a generic resume to long lists of personnel managers. Often such generic unsolicited resumes do not receive the attention that is received by a paper resume with a personal cover letter.

Web services are available for literature printing, but currently provide only a narrow spectrum of services/products. For example, a promotional literature mailing to a potential customer mailing list is accomplished by a plurality of service providers that need to be coordinated. A mail list service provider provides mailing lists. A literature designer generates the copy. A printer prints the copy and may also provide mailing services. One problem with literature designed on a computer and communicated electronically to the printer is that the literature printed by a copy or print shop may differ from the original design. Electronic literature commonly changes appearance or formation with the software, software settings, and printers used to view it. The multiple suppliers of products and services required for a literature mailing add additional cost.

There is a need for an electronically integrated direct-mail system to reduce costs associated with direct resume and other mailings and improve the quality of such mailings.

Another aspect of job seeking includes locating contacts within a company and directing a resume and/or letter to the appropriate contact within a specific company. Currently, contacts within a company can be independently researched with a web type service; however, these web services or databases do not provide contacts within a company which are specifically associated with an available position within the company.

### SUMMARY OF THE INVENTION

In accordance with one aspect of the invention, a method of operating a web based system to manage a subscriber's contact is provided. The method includes managing a subscriber's personal and business contacts by accessing a contacts manager web page, wherein the contacts web page provides the subscriber with contact information.

There is a need for a web based system to find contacts within a company where the contacts are associated with a particular job posting.

In another aspect of the invention, a method of operating a web based system to deliver a direct-mail piece is provided. The method includes a subscriber logging on to the home page of a web based system, building a mailing list from a mailing list web page accessed from the home page, building literature from a literature building web page accessed from the home page or the mailing list web page, displaying the created literature as an exact replica of the printed literature, and electronically sending a merged mailing list and literature file to a print shop.

In another aspect of the invention, a web based system to create a direct-mail piece is provided. The web based system includes a means for communicating from a subscriber computer to a server computer that includes a home page, a means for a subscriber to login from the home page to the web based system, a means for the web based system to create and deliver a direct-mail piece to a person or business, and a means for the web based system to provide a subscriber with a computer display of an exact replica of a direct-mail piece to be delivered. The web based system further includes a contacts manager module, a services module and a mailing list module.

In another aspect of the invention, a web based system to create a direct-mail piece is provided. The web based system includes a home page accessible from a subscriber's computer, a means for a subscriber to login from the home page to the web based system to create, view and deliver literature, a means for a subscriber to build a mailing list including names and addresses, a means for creating literature and electronically sending the created literature to the subscriber for display, and a means initiated by the subscriber for sending the created literature electronically for printing literature as displayed.

In another aspect of the invention, a method of operating a web based system to deliver a direct-mail piece is provided. The method including a subscriber logging on to the home page of a web based system, building a mailing list by selecting an icon on the home page and accessing a mailing list web page; entering search criteria information within fields of the mailing list web page to generate a list of prospective employers including names and addresses; building a resume by selecting an icon on the home page or mailing list web page and accessing a resume building web page, selecting or uploading a resume template from the resume building web page; entering information to be printed on the resume by accessing a web page from the resume building web page, and displaying the resume as constructed from the template and entered information, the displayed resume being an exact replica of the printed resume, before the resume is printed; building a cover letter by selecting an icon on the home page, the mailing list web page, or the resume builder web page, and accessing a cover letter building web page; selecting a cover letter template from the cover letter building web page; entering information to be printed on the cover letter; selecting an envelope message to be printed on the envelope of the cover letter; creating or uploading a signature file and entering this file to be printed on the cover letter; displaying the cover letter and envelope as constructed from the template and entered information, the displayed cover letter being an exact replica of the printed cover letter and envelope, before the cover letter and envelope are printed; building a business card by selecting an icon on the home page, the mailing list web page, the resume builder web page or the cover letter builder web page, and accessing a business card building web page; selecting a business card template from the business card building web page; entering information to be printed on the business card; displaying the business card as constructed from the template and entered information, the displayed business card being an exact replica of the business card, before the business card is printed; printing resumes, cover letters and business cards by selecting an icon from the home page, the mailing list web page, the resume builder web page, the cover letter builder web page or the business card building page, and accessing a checkout web page; and mailing or delivering the resumes, cover letters and business cards to the names and addresses listed on the mailing list.

In another aspect of the invention, a method of operating a web based system to compile a list of available jobs is disclosed. The method comprises generating a job search criteria input web page, wherein a user enters one or more job search criteria; executing a web based job search based on the user entered job search criteria, wherein the web based system searches one or more web sites which post available jobs, and/or provides job search criteria to one or more web search engines which search the web for available jobs; generating a job search results web page which displays a list of available jobs which satisfy the said user entered job search criteria; and executing a search for company contact information associated with one or more of the said list of available jobs.

In another aspect of the invention, a web based system to compile a list of available jobs is disclosed. The web based system comprises a server configured to perform (a) generating a job search criteria input web page, wherein the job search criteria input web page is configured to accept one or more job search criteria entered by a user; (b) executing a web based job search based on the user entered job search criteria, wherein the web based system searches one or more web sites which post available jobs and/or provides one or more job search criteria to one or more web search engines which search the web for available jobs; (c) generating a job search results web page which displays a list of available jobs which satisfy the said user entered job search criteria; and (d) executing a search for company contact information associated with one or more of the said list of available jobs.

In another aspect of the invention, a method of operating a web based system to compile a list of available jobs is disclosed. The method comprises generating a company contacts search criteria input web page, wherein a user enters one or more contacts search criteria; executing a web based company contacts search based on the user entered company contacts search criteria, wherein the web based system searches one or more web accessible databases for company contact information; generating a company contacts search results web page which lists company contacts which satisfy the said user entered company contacts search criteria; and executing a search for available jobs at the companies associated with one or more of the said list of company contacts.

In another aspect of the invention, a web based system to compile a list of available jobs is disclosed. The web based system comprises a server configured to perform (a) generating a company contacts search criteria input web page, wherein a user enters one or more contacts search criteria; (b) executing a web based company contacts search based on the user entered company contacts search criteria, wherein the web based system searches one or more web accessible databases for company contact information; (c) generating a company contacts search results web page which lists company contacts which satisfy the said user entered company contacts search criteria; and (d) executing a search for available jobs at the companies associated with one or more of the said list of company contacts.

In another aspect of the invention, a method of operating a web based system is disclosed. The method comprises executing a job campaign process, wherein the job campaign process delivers a subscriber's selected documents to selected contacts within a company or organization.

In another aspect of the invention, a web based system is disclosed. The web based system comprises a means for executing a job campaign process, wherein the job campaign process delivers a subscriber's selected documents to selected contacts within a company or organization.

In another aspect of the invention, a method of operating a web based system is disclosed. The method comprises performing a web based job search tailored to specific search criteria selected by a subscriber, wherein a meta job search engine provides search criteria for one or more accessible job search engines, and the meta job search engine compiles a collection of available job positions matching the specific criteria selected by the user.

In another aspect of the invention, a web based system to perform a web based job search is disclosed. The web based system comprises a means for performing a web based job search tailored to specific search criteria selected by a subscriber, wherein a meta job search engine provides search criteria for one or more accessible job search engines, and the meta job search engine compiles a collection of available job positions matching the specific criteria selected by the user.

In another aspect of the invention, a method of operating a web based system is disclosed. The method comprises executing a job campaign process, wherein the job campaign process delivers a subscriber's selected documents to selected contacts within a company or organization.

In another aspect of the invention, a web based system is disclosed. The system comprises a means for executing a job campaign process, wherein the job campaign process delivers a subscriber's selected documents to selected contacts within a company or organization.

One advantage of the present invention is a reduction in costs associated with the creation and delivery of a direct-mail piece.

Another advantage resides in eliminating the need to coordinate multiple suppliers of services.

Another advantage is that a user is able to better focus a direct mailing campaign and reach a wider audience based on specific criteria.

Another advantage, in the case of a job seeker, resides in a single, integrated web based service provider which creates and provides a focused distribution of resumes to potential employers selected from a mailing list.

Another advantage resides in saving the job seeker time and costs in direct mailings of resumes, cover letters, and business cards, etc.

Yet another advantage, in the case of a job searcher, resides in a single, integrated web based service provider which enables a user to search for available jobs and company contacts associated with the available jobs.

Still further advantages will become apparent to those of ordinary skill in the art on reading and understanding the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIGS. 1A and 1B are an illustration of a site map, in accordance with one embodiment.

FIG. 2 is an illustration of a web based service providing web based resume direct, mailing service, in accordance with one embodiment.

FIG. 3 is an illustration of a mailing list web page, in accordance with one embodiment.

FIG. 4 is an illustration of a contact manager web page, in accordance with one embodiment.

FIG. 5 is an illustration of a resume builder web page, in accordance with one embodiment.

FIG. 6 is an illustration of a contact information recordation system, in accordance with one embodiment.

FIG. 7 is an illustration of an experience information recordation page, in accordance with one embodiment.

FIG. 8 is an illustration of an education information entry web page, in accordance with one embodiment.

FIG. 9 is an illustration of a professional association membership's information entry web page, in accordance with one embodiment.

FIG. 10 is an illustration of a hobbies information entry web page, in accordance with one embodiment.

FIGS. 11A AND 11B are illustrations of a cover letter builder web page, in accordance with one embodiment.

FIG. 12 is an illustration of a business card builder web page, in accordance with one embodiment.

FIG. 13 is an illustration of a checkout web page, in accordance with one embodiment.

FIGS. 14A-14J are web site maps illustrating the mapping of outside pages of a web based system according to one exemplary embodiment of this disclosure.

FIGS. 15A-15F are web site maps illustrating the mapping of inside pages of a web based system according to one exemplary embodiment of this disclosure.

FIGS. 16A-16C illustrate web page screens according to one exemplary embodiment of this disclosure.

FIGS. 17A-17B illustrate web page screens according to one exemplary embodiment of this disclosure.

FIGS. 18A-18F illustrate web page screens and documents associated with a campaign according to one exemplary embodiment of this disclosure.

### DETAILED DESCRIPTION OF THE PREFERRED EMBODIMENTS

Described below is a detailed description of a contacts manager method and system, and a method and system for operating a web based service to create and deliver a direct-mail piece. The exemplary embodiments illustrated and described are directed to a job seeker service which may include delivery of a resume, cover letter and/or other mail piece. In addition, this disclosure provides a detailed description of a web based system and method to compile a list of available jobs and/or contacts associated with the available jobs However, this disclosure is not limited to job seeker services.

The contacts manager method and system are applicable to various embodiments which include the management of contacts to satisfy personal or business objectives. For example, in the management of contact information related to associates, friends, suppliers, customers, etc. In addition, the web based service to create and deliver a direct-mail piece, as disclosed, provides a method and system capable of delivering one or more mail pieces to various recipients, which may include associates, friends, suppliers, customers, etc.

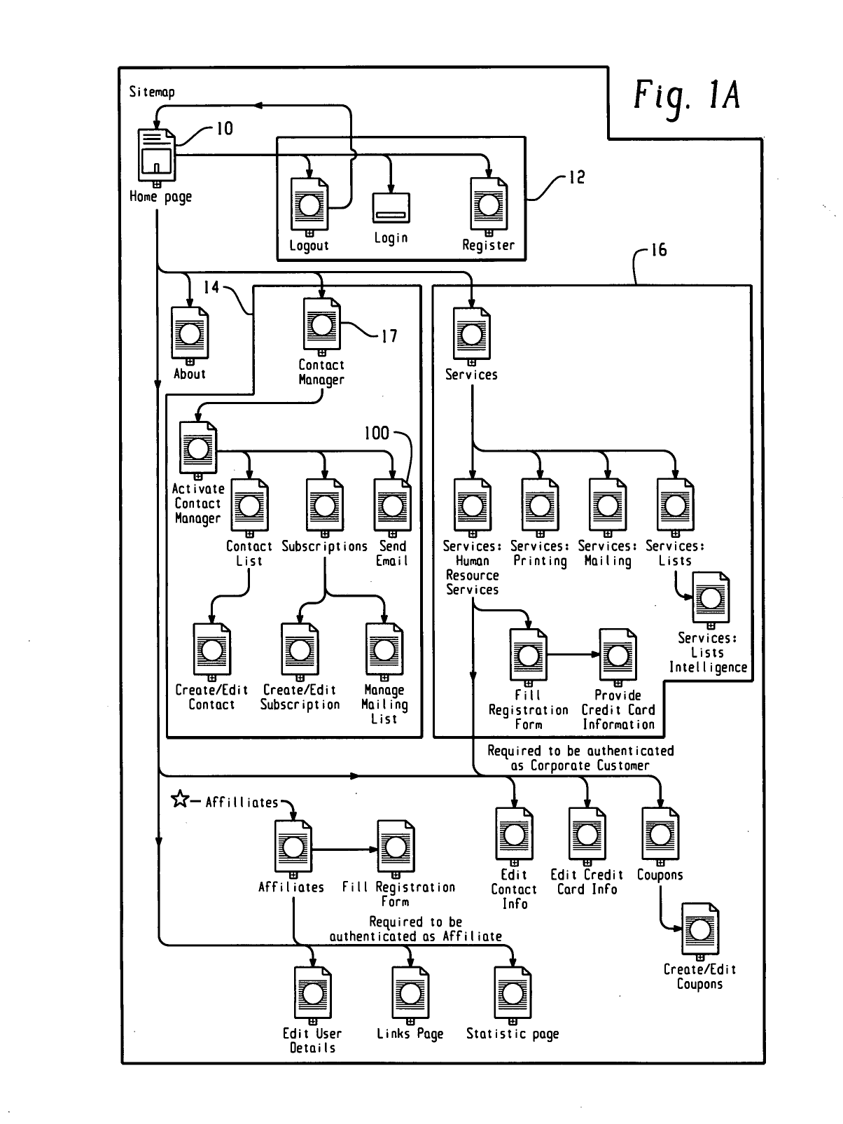

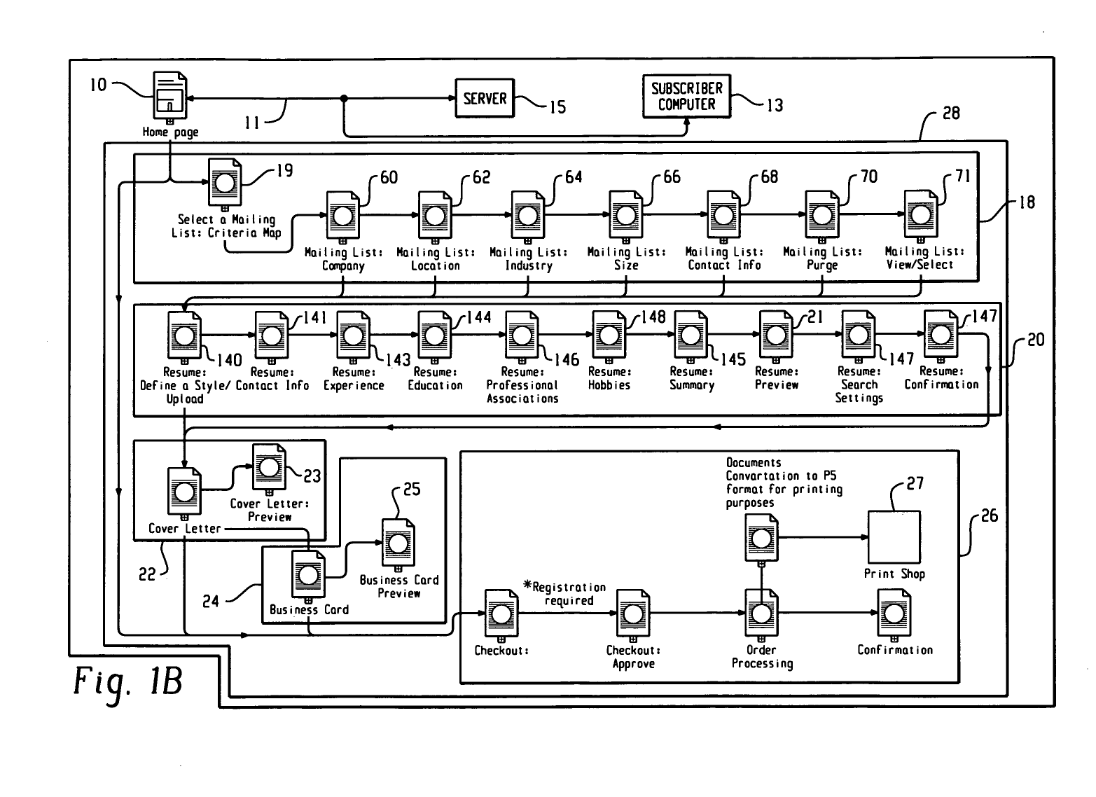

With reference to FIG. 1 A and FIG. 1 B, a subscriber logs onto the home page 10 of a web based service provider for direct-mail pieces. A subscriber connects to the home page 10 by accessing a server 15 via the internet/intranet 11 with a computer 13. The hardware connection 11 of the server 15 and the subscriber's computer 13 is accomplished by means 11 such as an internet dial up service, internet DSL service, internet broadband cable service, etc. The server 15 stores the data and programs necessary to display the home page 10 to a subscriber in conjunction with the subscriber's computer software. In addition, the server 15 executes the software necessary to provide the web pages and services discussed below. As represented in the site map of FIG. 1A and FIG. 1B, the server 15 executes one or more programs to display the web pages represented by this site map. These web pages are stored in the memory of one or more servers. If more than one server 15 is used to provide storage and access to the web sites, the servers communicate with each other by means 11 of the internet/intranet or other connection protocol. The subscriber's computer 13 requires software to communicate and access a web page located at a server 15. This type of software is readily available and includes means such as Internet Explorer®), Netscape®, etc. As described below in conjunction with a resume services embodiment, this web based service provides for the design of resumes, cover letters, business cards, or other literature and the accurate rendition of designed literature to be printed for delivery or picked up. The literature viewable on-line is an exact replica of the item as it will be printed. This web based service also provides for building a focused mailing list and the management of people contacted in the mailing or follow-up mailings or telephone calls. These and other services can be performed individually or in various orders. The orders described below are exemplary only. In this illustration, the subscriber first uses the contacts system to build a mailing list and manage the contacts by accessing the mailing list building web page by selecting an icon labeled “select mailing list” displayed on the home page 10.

As discussed above and with reference to FIGS. 1A and 1B, the site map of the server configuration represents the web pages stored on a server 15 or servers and available to a subscriber. Available website modules and web pages may include the following: login/logout/registration module 12, contacts manager module 14, services module 16, mailing list module 18, resume builder module 20, cover letter builder module 22, business card builder module 24 and a checkout module 26. As represented in FIG. 1B, the mailing list module 18, resume builder module 20, cover letter builder module 22, business card builder module 24, and checkout module 26 are combinable 28 to provide a step-by-step process for a subscriber to conduct a job search campaign.

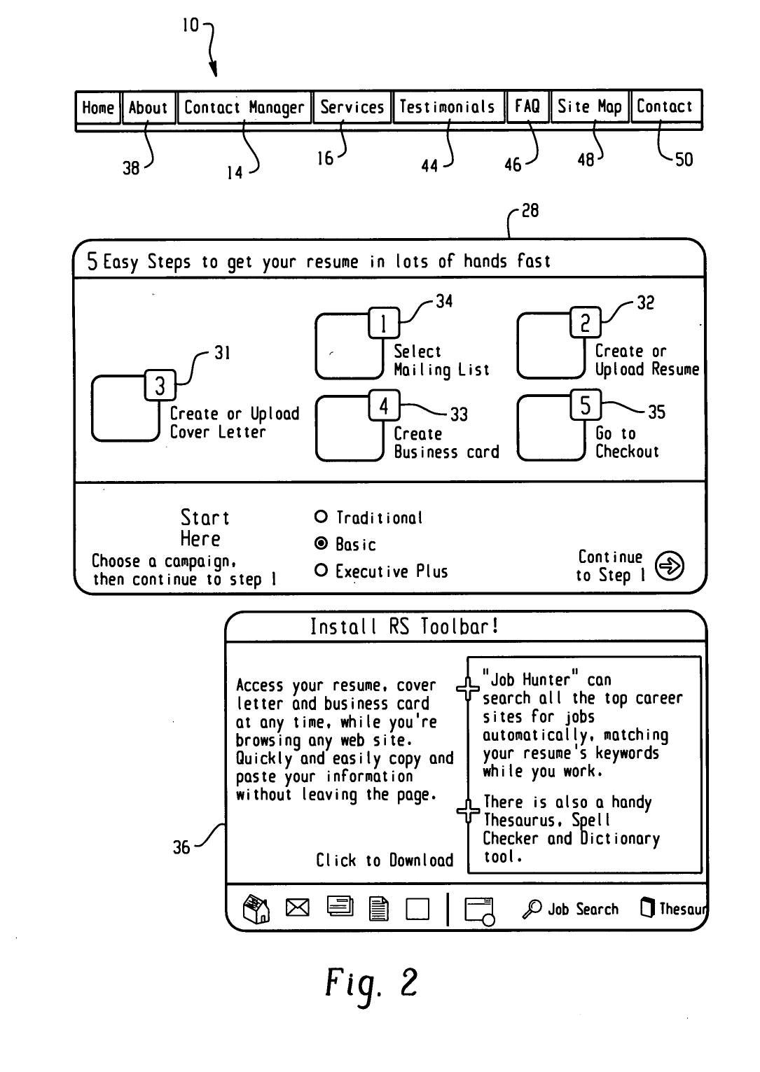

FIG. 2 represents the home web page 10 of a web based resume creation and direct mailing service to conduct a job search campaign. This web page provides the subscriber with access to a variety of on-line tools to build and print a resume 32, build a mailing list 34 for resume delivery with the ability to manage contacts associated with the generated mailing list, build and print cover letters 31 and business cards 33, and delivery 35 of printed items to prospective employees.

As discussed above, according to one embodiment a web based resume creation and direct mailing service is provided. Referring to FIG. 2, a subscriber accesses the home page 10 of the resume service by using a computer 13 with a connection to the appropriate server 15. The subscriber accesses the home page 10 using a computer 13 that is connected to the internet or an intranet 11. A web browser is used to navigate the internet or intranet 11 to communicate with the appropriate server 15. In one embodiment, the web service platform is ASP-Net® by Microsoft. After accessing the home page 10, the subscriber is provided a returning user login and a new user registration on-line procedure. The returning user login module provides services for subscribers whom have forgotten a password and the ability to have a password sent via e-mail. Specifically, the home page 10 can provide the subscriber with a variety of selectable options that include how to use and benefit from being a member of a web based resume direct mailing service, free trial information, e-mail delivery to top recruiters, information regarding URL listing of a members resume, information regarding direct-mail campaigns, privacy protection information, a job hunter meta search engine 36 and access to a step-by-step web service providing a resume direct mailing campaign 28. In addition, the subscriber can select a web page that provides information about the provided web based resume direct mailing services 38, contact manager services 14, other services 16, testimonials 44, frequently asked questions 46, a site map 48, and contact information 50 regarding the web based resume direct mailing service. Other user selections include legal information, affiliate information, order placement/status and informing a friend.

After a subscriber is successfully logged in, the subscriber can access the contacts manager module 14, a services module 16, and a mailing list module 18 to create, view and deliver direct-mail pieces to people or businesses selected via the mailing list module 18.

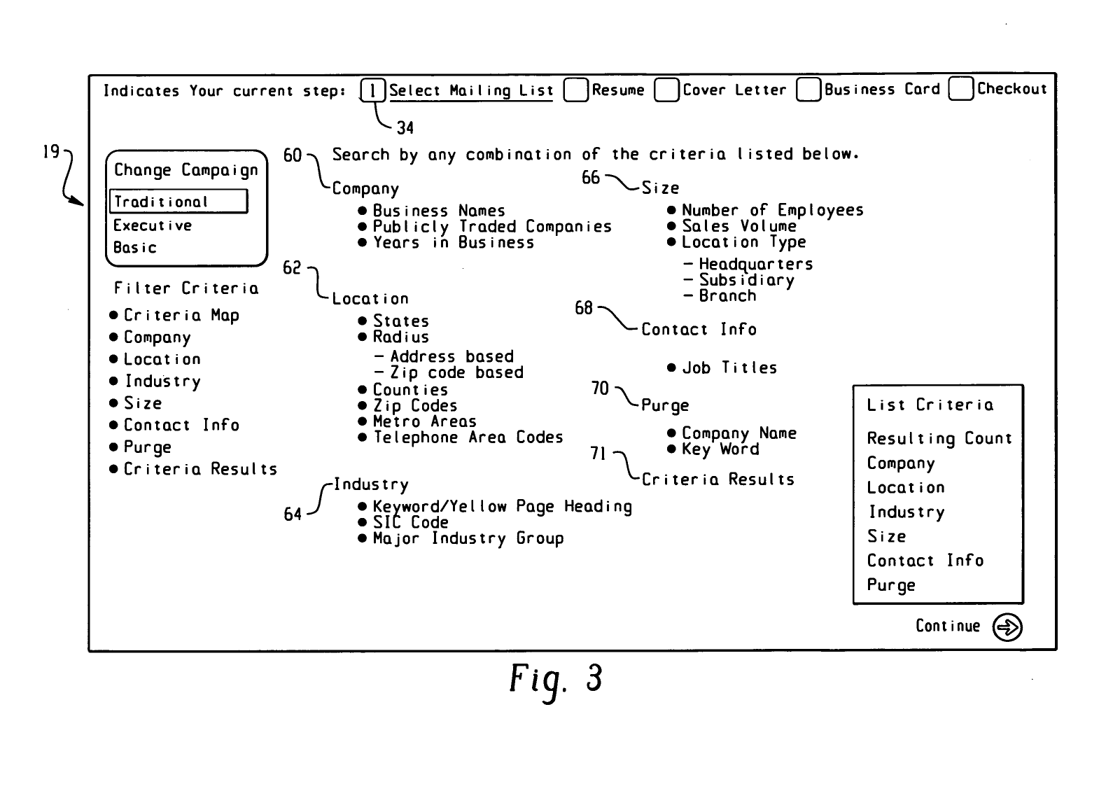

Referring to FIG. 2, illustrated is a home page 10 of a web based resume creation and direct mailing system as displayed on the subscribers computer display. According to one embodiment, a step-by-step process 28 is provided for a user, i.e. a job seeker, by way of a web page to execute a job search campaign. The subscriber is provided a selection of steps that include building a mailing list 34, creating or uploading a resume 32, creating or uploading a cover letter 31, creating a business card 33 and checking out 35. As illustrated in FIG. 3, step 1 34 provides the subscriber a web page to build a mailing list 19. The mailing list module 18 provides the user with the ability to generate mailing lists of companies and company personnel based on company name 60, location 62, industry 64, size 66 and contact information 68. The mailing list module 18, as represented by the web page 19 illustrated in FIG. 3, provides the subscriber with the ability to view and select lists 71. In addition, a purge list 70 function provides the subscriber with the ability to remove existing lists created by the user at an earlier time. The mailing list module 18 accesses one or more databases to generate a mailing list based on the subscriber's criteria. In addition, the subscriber can customize the mailing list module 19 to limit a user's access to specific data within a database, such as disqualifying a specific company from any mailing list criteria result. In one embodiment of the invention, the mailing list module 18 accesses a Dun & Bradstreet company profile database.

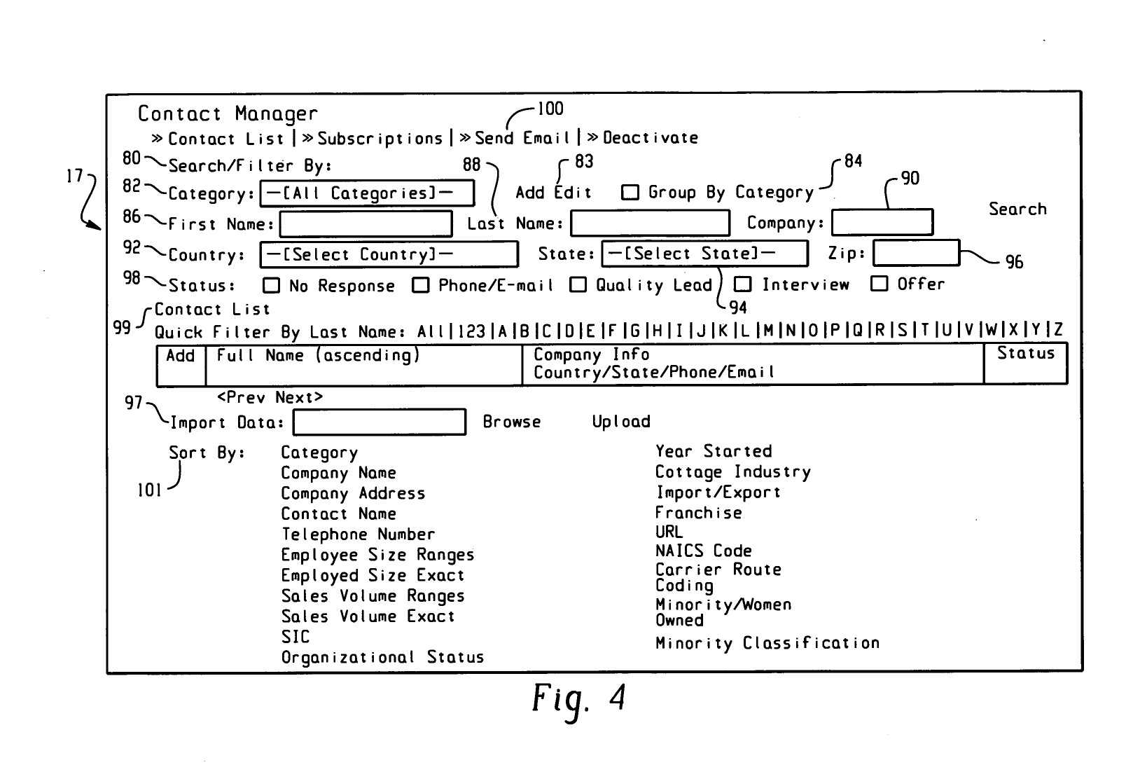

As illustrated in FIG. 4, the contact manager module 14 provides the subscriber a way to manage contacts for people and businesses, including a search/filter 80 based on a criterion of categories 82, category group 84, first name 86, last name 88, company name 90, country 92, state 94, zip code 96, etc. In addition, a sort function 101 further enables a subscriber to sort contacts by criteria such as category 101, contact name 101, company address 101, contact name 101, telephone number 101, employee size ranges 101, employee size exact 101, sales volume ranges 101, sales volume exact 101, SIC 101, organizational status 101, year started 101, cottage industry 101, import/export 101, franchise 101, URL 101, NAICS code 101, carrier route coding 101, minority/women owned 101 and minority classification 101.

According to one embodiment, a status field 98 provides information to a subscriber indicating if a contact or prospective employer responded to a communication, requires a telephone call or e-mail, is considered a quality lead, granted an interview, and/or extended an offer for employment. Data regarding the contact entries is inputted by a subscriber or imported from a database. In addition, the subscriber can customize the mailing list module 19 to limit a user's access to specific data within a database, such as disqualifying a specific company from any mailing list criteria result.

The contacts manager module 14 provides the subscriber with an on-line secure system to manage contacts. The user creates and edits contacts of professional or personal interest. These contacts are available to the subscriber for generating mailing lists for direct-mailings. In addition, the subscriber has the ability to e-mail 100 the contacts directly.

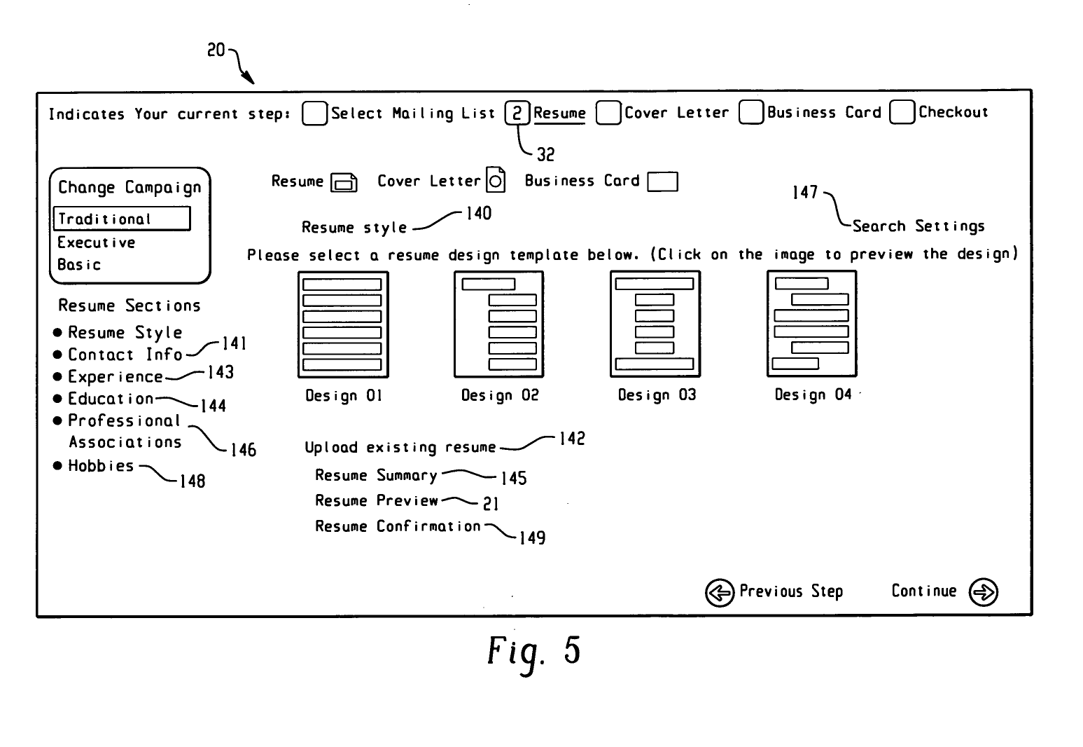

As illustrated in FIG. 5, step 2 32 provides the subscriber access to a resume builder module 20 web page. The resume builder module 20 web page provides the subscriber with a system of building a resume. This module 20 provides the subscriber with a selection of provided resume design styles 140 or the subscriber can upload an existing resume file 142. Contact information 141, work experience 143, education 144, professional association memberships 146 and hobbies 148 are provided by the subscriber to the resume builder module 20. The subscriber has access to a resume summary 145, a resume preview 21 and a resume confirmation 149 selection. The resume builder has the additional feature of search settings 147. The search settings 147 are used by the user for employment searching. This includes access to meta search engines 36.

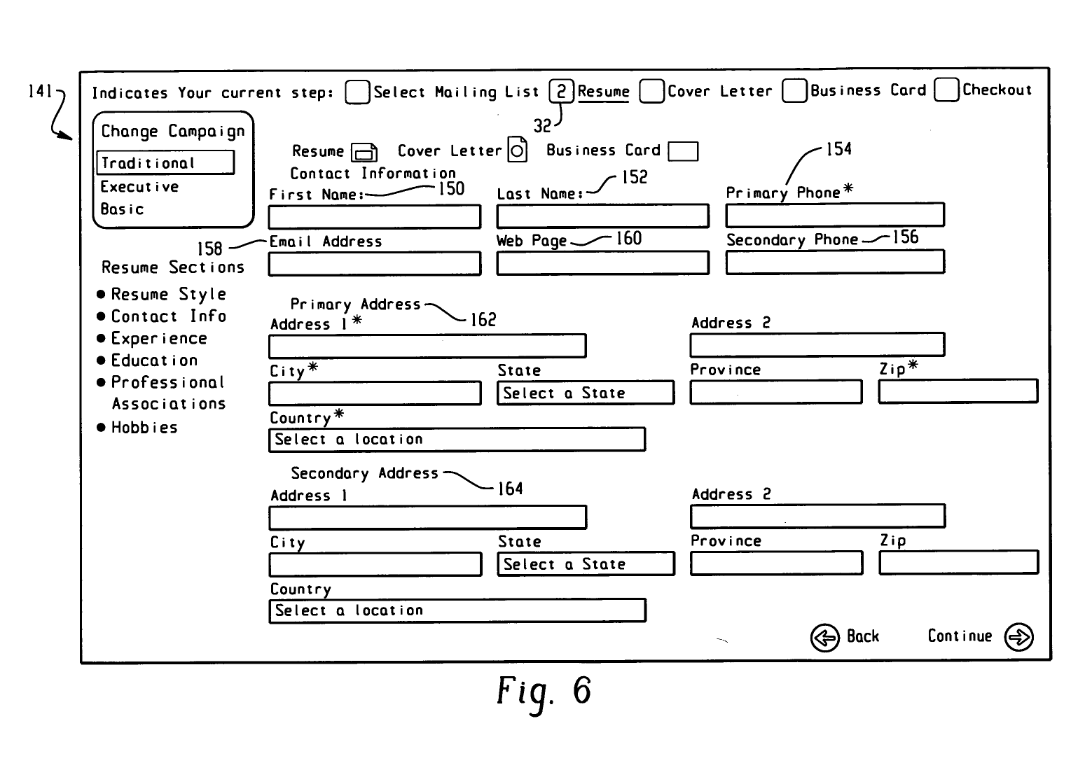

As illustrated in FIG. 6, the subscriber enters contact information 141 by accessing a contact information web page via the resume builder module 20 web page. The subscriber contact information fields available for the subscriber include the subscriber's first name 150, last name 152, primary phone 154, secondary phone 156, e-mail address 158, web page 160, primary addresses 162 and secondary addresses 164.

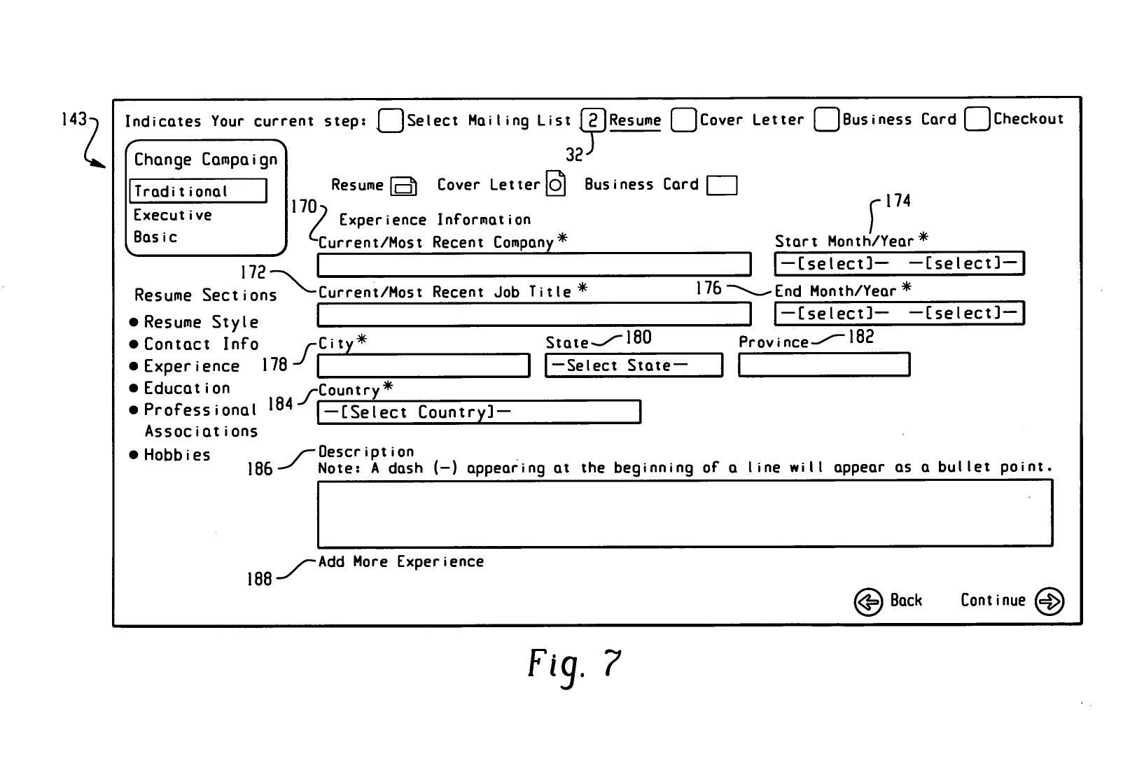

As illustrated in FIG. 7, the subscriber enters experience information 143 by accessing the experience information web page via the resume builder module 20 web page. The subscriber experience information fields available for the subscriber include the current/most recent company of employment 170, the current/most recent job title 172, starting 174 and ending month 176 of most recent/current employment, city of current/most recent employer 178, state of current/most recent employer 180, province of current/most recent employer 182 and country of current/most recent employer 184. In addition, the subscriber experience information 143 fields include a subscriber provided description 186 of the current/most recent experience. After entry of the subscriber current/most recent employment experience, additional experience information 188 can be added.

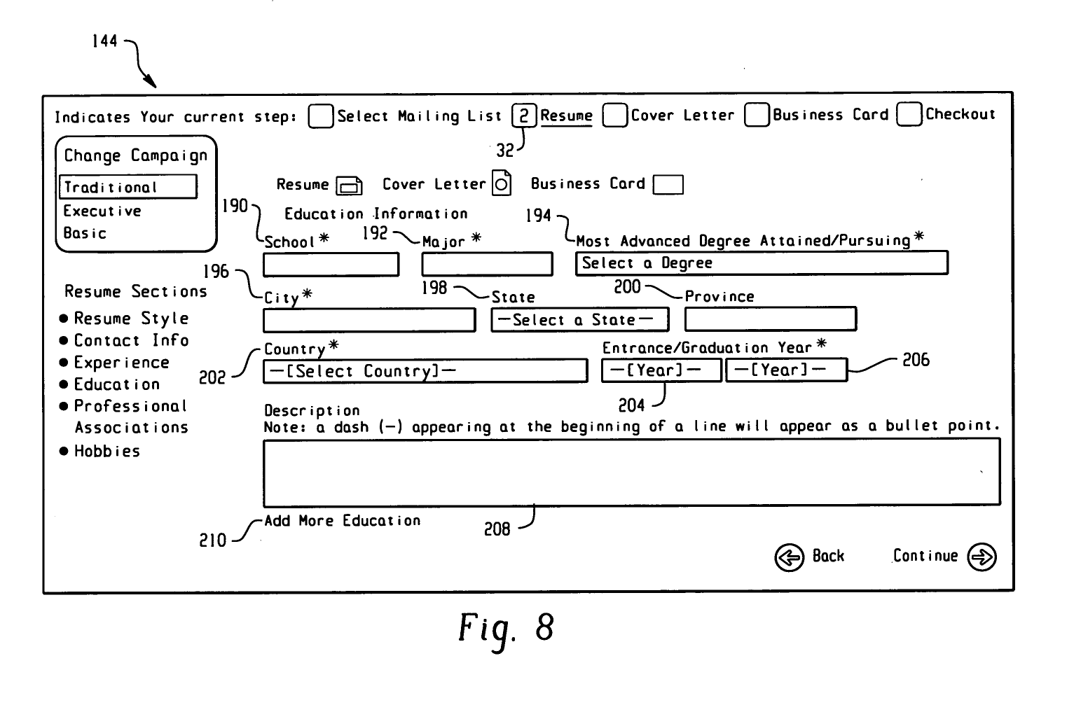

As illustrated in FIG. 8, the subscriber enters education information 144 by accessing the education information web page via the resume builder module web page 20. The user education information fields available include schools attended 190, majors 192, most advanced degree attained or pursuing 194, school city 196, school state 198, school province 200, school country 202 and entrance 204 and graduation year 206 of schools attended. In addition, the subscriber education fields include a subscriber provided description 208 of each school attended. After entry of a school attended by the subscriber, additional schools can be added 210.

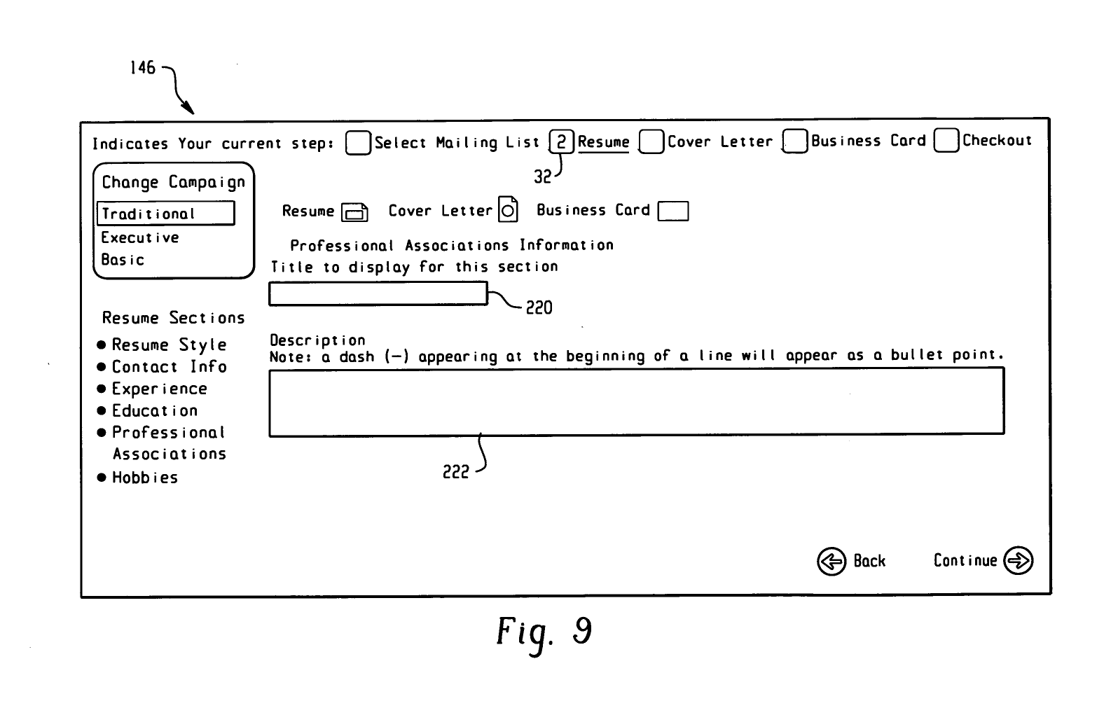

As illustrated in FIG. 9, the subscriber may enter professional association information 146 by accessing the professional association information web page 146 via the resume builder module web page 20. The subscriber professional association information fields available include a title 220 to be displayed on the resume for this information, and a description field 222 regarding the nature of the professional association membership. The description field 222 provides the subscriber with the ability to insert bullet points within the description field 222 of the printed resume. Multiple professional association memberships can be entered by the subscriber.

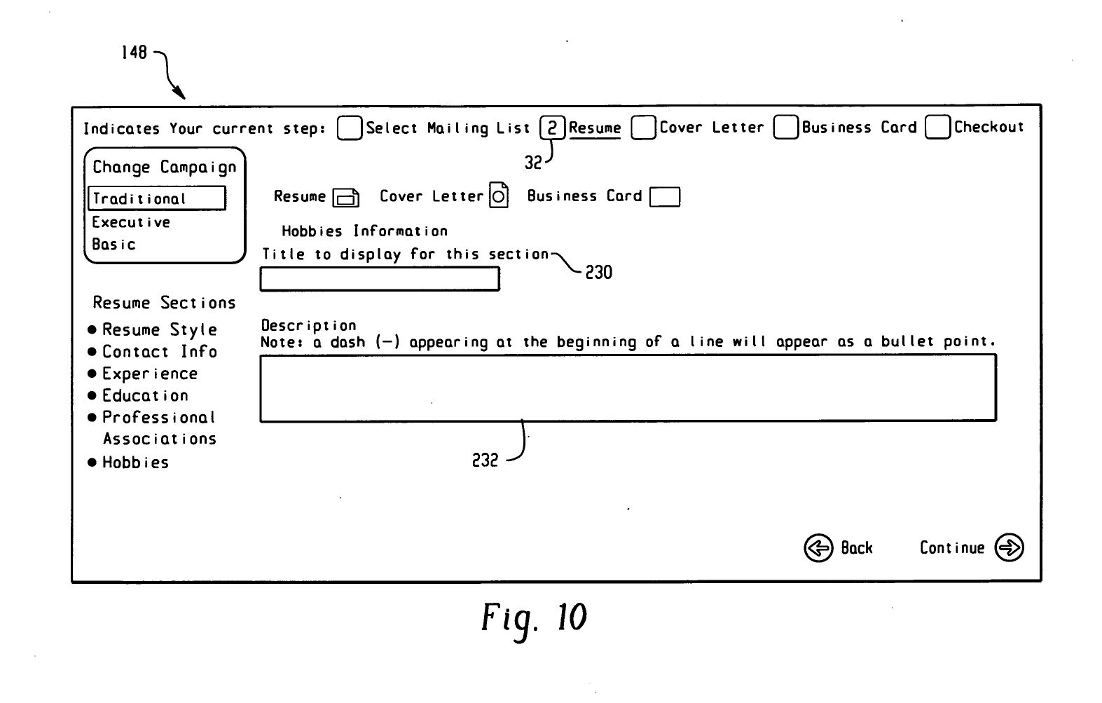

As illustrated in FIG. 10, the subscriber may enter hobby information 148 by accessing the hobby information web page via the resume builder module web page 20. The hobby information fields available include a title 230 to be displayed for the hobby information section of the resume, and a description 232 of the subscriber's hobby. The hobby information field 232 provides the subscriber with the ability to insert bullet points within the hobby information field 232 of the printed resume. Multiple hobbies can be entered by the subscriber.

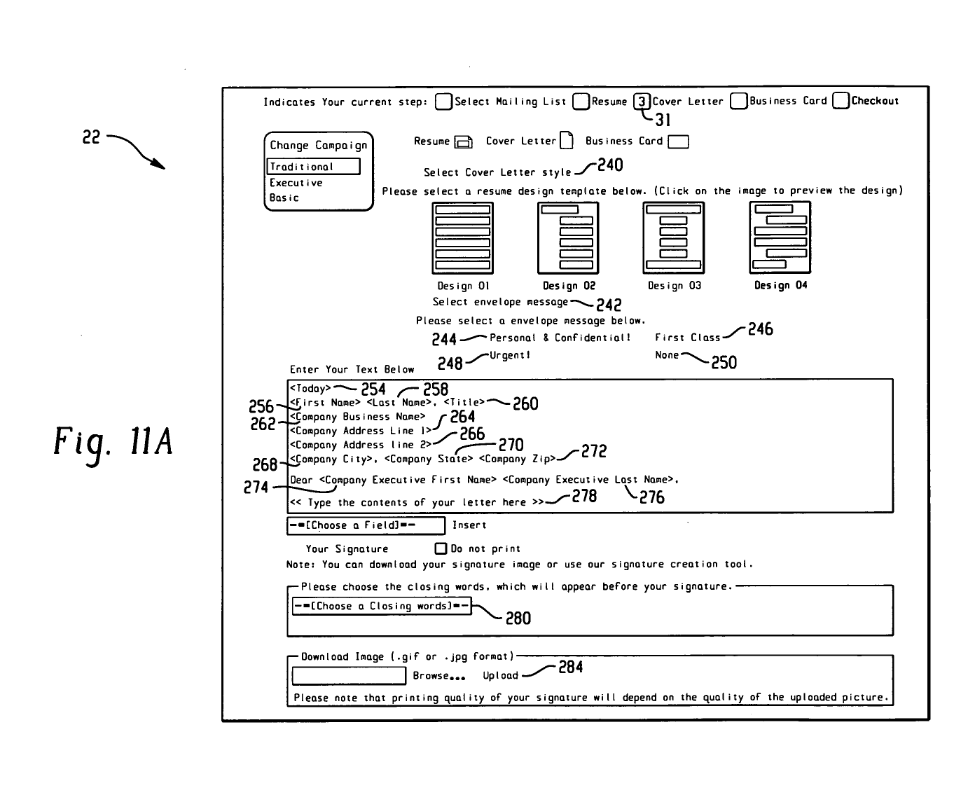

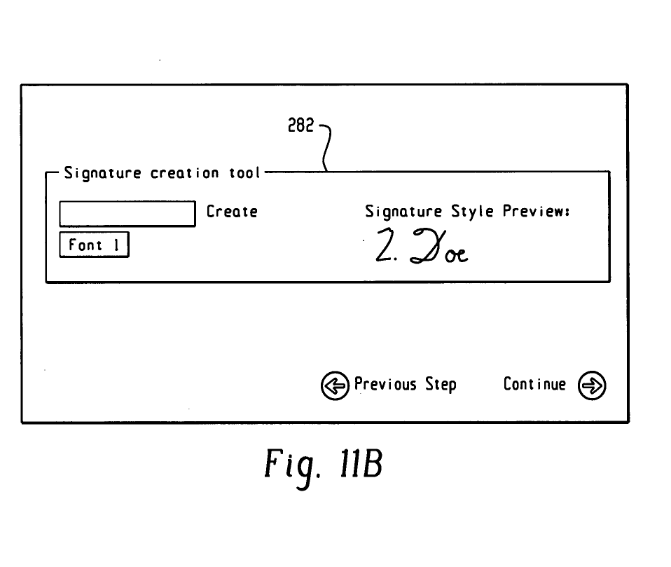

Referring to FIG. 2, FIG. 11A and FIG. 11B, step 3 31 of the process to provide a job search campaign includes creating or uploading a cover letter. The cover letter builder web page 22 provides the subscriber with a system of building a cover letter. This web page provides the subscriber with a selection of provided cover letter design styles 240. The cover letter builder web page 22 provides the subscriber with the ability to select an envelope message 242, such as “personal & confidential” 244, “first class” 246, “urgent!” 248 or none 250. The cover letter builder web page 22 provides a section 252 for the subscriber to enter the text of the cover letter. This section provides a formatted list of relevant fields that enable the subscriber to enter the details of the cover letter. The fields include date 254, first 256 and last 258 name, title 260, company business name 262, company address line 1 264 and line 2 266, company city 268, company state 270 and company zip code 272. In addition, a field is provided for the company executive's first 274 and last name 276 of whom the cover letter is addressed and a field 278 for the contents of the subscriber provided text. The cover letter builder web page 22 also provides the subscriber with the ability to select closing words 280 that will appear before their signature and create 282 or upload 284 a signature file to be printed on the cover letter.

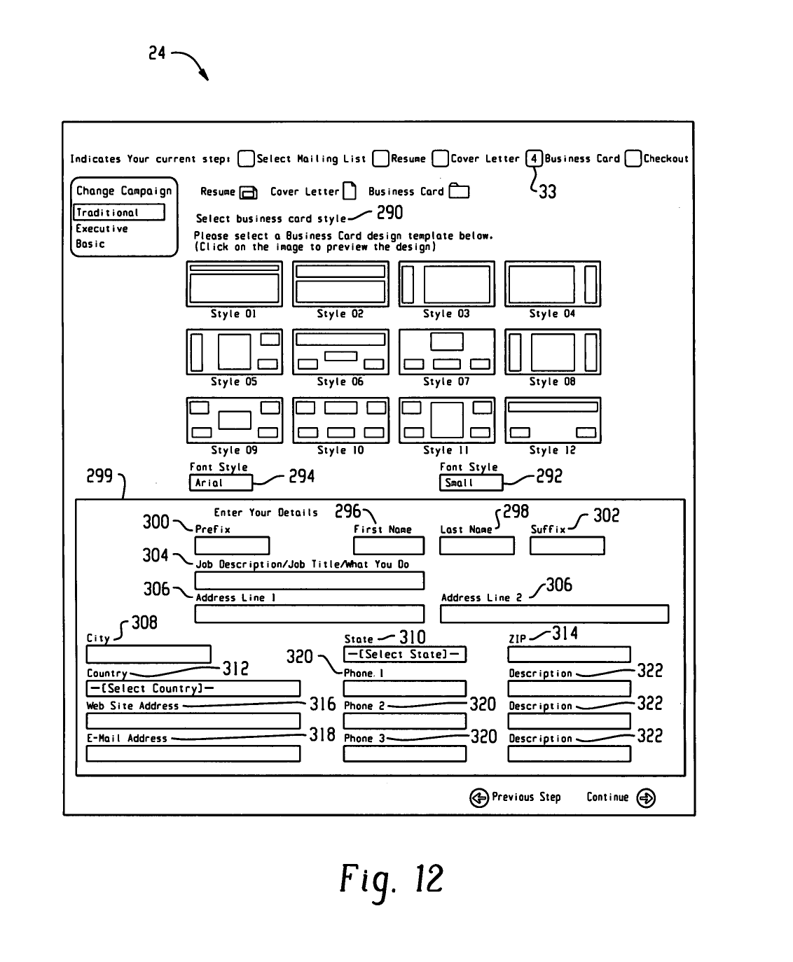

Referring to FIG. 2, FIG. 12A and FIG. 12B, step 4 33 of the process to provide a job search campaign includes a business card creation web page 24 selection 33. The business card web page 24 provides the subscriber with a system of building a business card. This web page provides the subscriber with a selection of provided business card design styles 290. The business card creation web page 24 provides the subscriber with the ability to select a font size 292 and style 294, enter first 296 and last 298 name including a prefix 300 or suffix 302, enter a job title or description 304, and provide the subscriber's address information, including street 306, city 308, state 310, country 312 and zip code 314. Also, the subscriber has the ability to enter a web site address 316, e-mail address 318, and phone numbers 320 with an appropriate description 322, to be printed on the business cards.

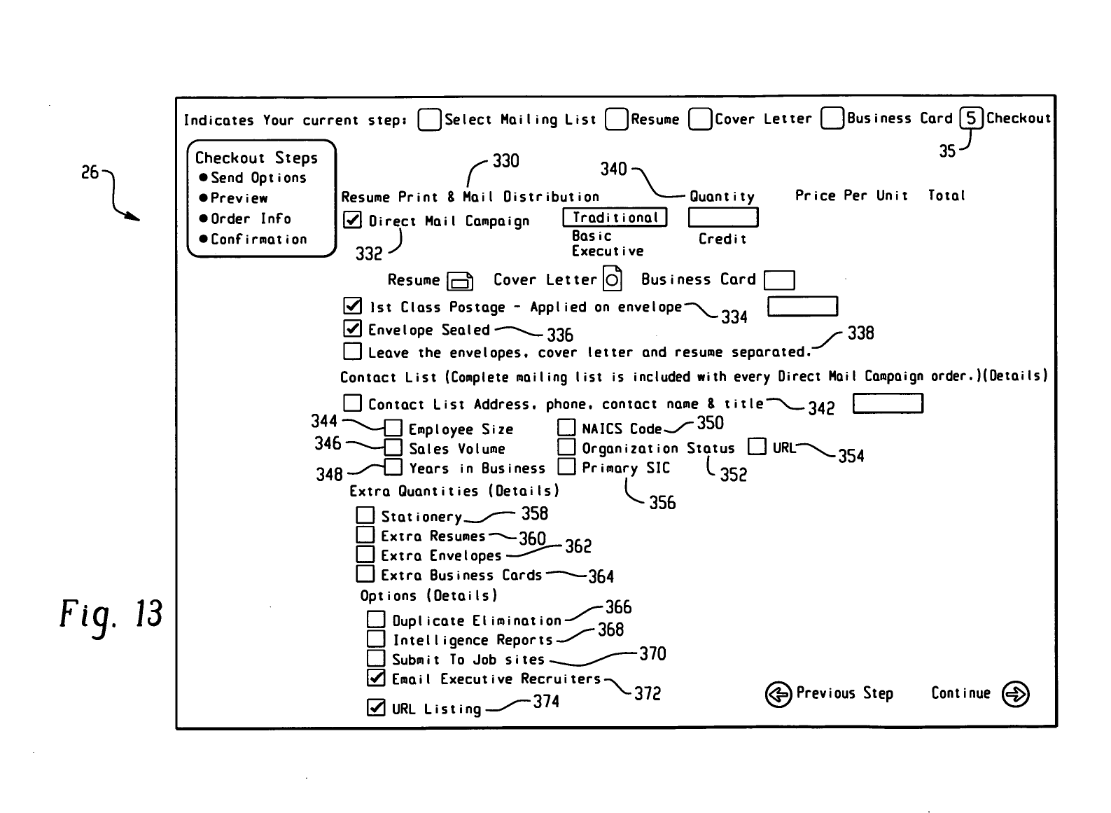

Referring to FIG. 2 and FIG. 13, step 5 35 of the process to provide a job search campaign includes a checkout web page 26. The checkout web page 26 provides the subscriber with a system of procuring literature items created, as discussed above, and distributing the literature items created. This web page provides the subscriber with resume print and distribution services 330 that include selection of a type 332 of direct-mail campaign. Types of direct-mail campaigns include, but are not limited to, traditional, basic and executive packages that provide specific quantities of resumes, cover letters, business cards and mailings, etc. The subscriber can select first class postage 334; envelope sealed or unsealed 336; separated envelopes, cover letter and resume 338; and quantity 340 of items requested. In addition, a contact list selection 342 is provided to the subscriber that can include employee size 344, sales volume 346, years in business 348, NAICS code 350, organization status 352, URL 354 and primary SIC 356. The subscriber can also select specific quantities of stationary 358, resumes 360, envelopes 362 and business cards 364 that are outside the scope of the direct-mail campaign type package selected. Other options available to the subscriber include services to eliminate duplication 366, intelligence reports 368, submission to job sites 370, e-mailing executive recruiters 372 and URL listings 374. All document or literature to be printed can be previewed by the subscriber before being electronically sent to a print shop 27. Screen to print technology provides an actual rendition of the documents to be printed and previewed by the user. Furthermore, the operation of the checkout module 26 includes formatting of documents to be electronically sent to a print shop for printing and/or delivery to the names and addresses listed on the subscriber's mailing list.

In addition to the web based resume direct mailing service described above, the subscriber can access a service module 16 independently of the step-by-step process associated with the job search campaign described above. The services module 16 provides the subscriber print and mail services, human resource services, intelligence research services and access to the contacts list & on-line management module 14. The corporate human resource services web page provides access for corporate users, such as human resource managers. For example, HR managers who provide ex-employees with a resume service as part of a severance package. Other services available include, but are not limited to, resumes, cover letters, business cards, etc. In addition, other wide-area print distribution and direct mailing is available to the subscriber. The intelligence research services web page provides the subscriber with research services to obtain reports regarding company closings, salaries, recently hired employees and firings, financial disclosures, etc. The contacts list & on-line management web page provides the subscriber with the ability to order a contact list that includes information regarding a company. This information includes employee size, contact name and title, sales, years in business, NAICS code, organization status, URL, etc.

As discussed above, the services module 16 provides the subscriber with access to multiple services regarding direct-mailings. The subscriber prints at locations that have printers with compatible software including exclusive screen to print technology, to provide matching literature as displayed on the subscriber's computer display. These locations can include print shops, copy centers or other print service providers available by agreement. Other services provided to the subscriber include complete mailings, list generation, resume creation/editing, cover letter and business card creation/editing, and screen to print technology. The services module also provides the ability for the subscriber to complete a registration form and provide charge account information for services ordered.

Other features of the web based system to create and deliver a resume are now described with reference to FIG. 2. The home page 10 of the resume creation and delivery service provides the subscriber with the additional feature of access to a toolbar download and install feature 36 to enable the subscriber to access their resume, cover letter and business card anytime the subscriber is browsing other web sites. In addition, the toolbar enables a subscriber to quickly copy and paste information from the subscriber's resume, cover letters, business card, etc. to another website or document. The toolbar provides the subscriber with input fields for selected search engines related to job searching, spell checking, and others such as a thesaurus and dictionary. Toolbar buttons are provided for configuring the toolbar, help and support, job prospects and contact information.

In addition, the home page 10 of the resume creation and delivery service provides the subscriber with access to information about the resume delivery service 38, information regarding frequently asked questions 46 and job information for job hunters as related to direct-mail campaigns. The home page 10 further provides the subscriber with information regarding the privacy policy of the resume delivery service provider.

Described heretofore, with reference to FIGS. 1-13, is a web based system and method to create and manage contact information, according to one exemplary embodiment of this invention. In addition, described heretofore, with reference to FIGS. 1-13, is a web based system and method to create and deliver mail pieces, for example resumes and cover letters, according to an exemplary embodiment of this invention. Notably, the integration of the disclosed contacts manager module and resume builder module/cover letter builder provide a system to effectively direct a job seeker's resume to one or more selected contacts, where the contact information is provided by one or more of personal contacts and/or retrieved from a company information database which may be commercially available. Moreover, the web based system and method described heretofore with reference to FIGS. 1-13 provides a job hunter with a list of available jobs through access to a meta search engine as illustrated in FIG. 2. The combination of contacts management, document/resume creation and job searching provides a basis for conducting an effective job seeking campaign targeted at a broad group of companies and/or a narrowly tailored group of companies selected on the basis of criteria entered by the job seeker via the contacts manager module.

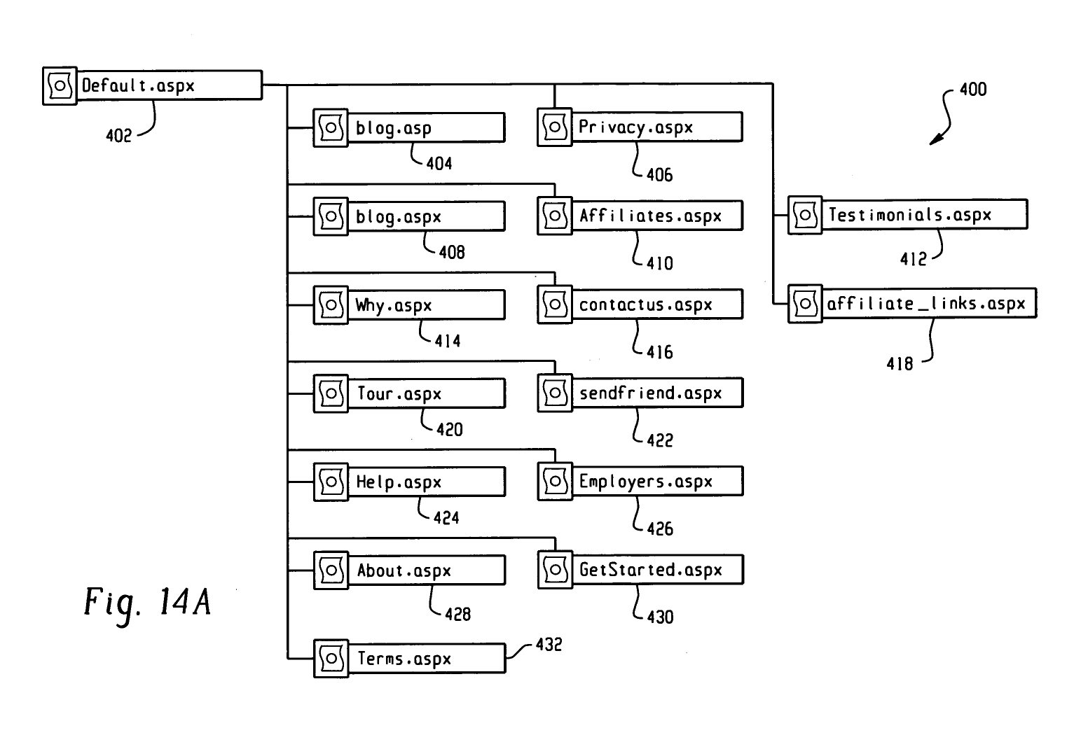

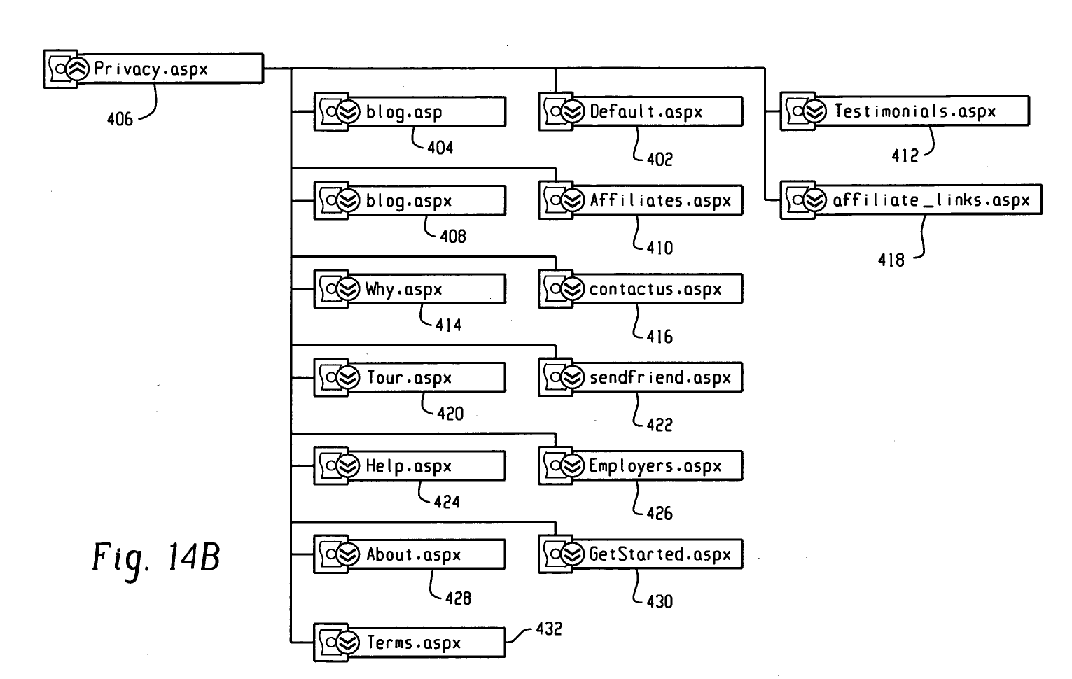

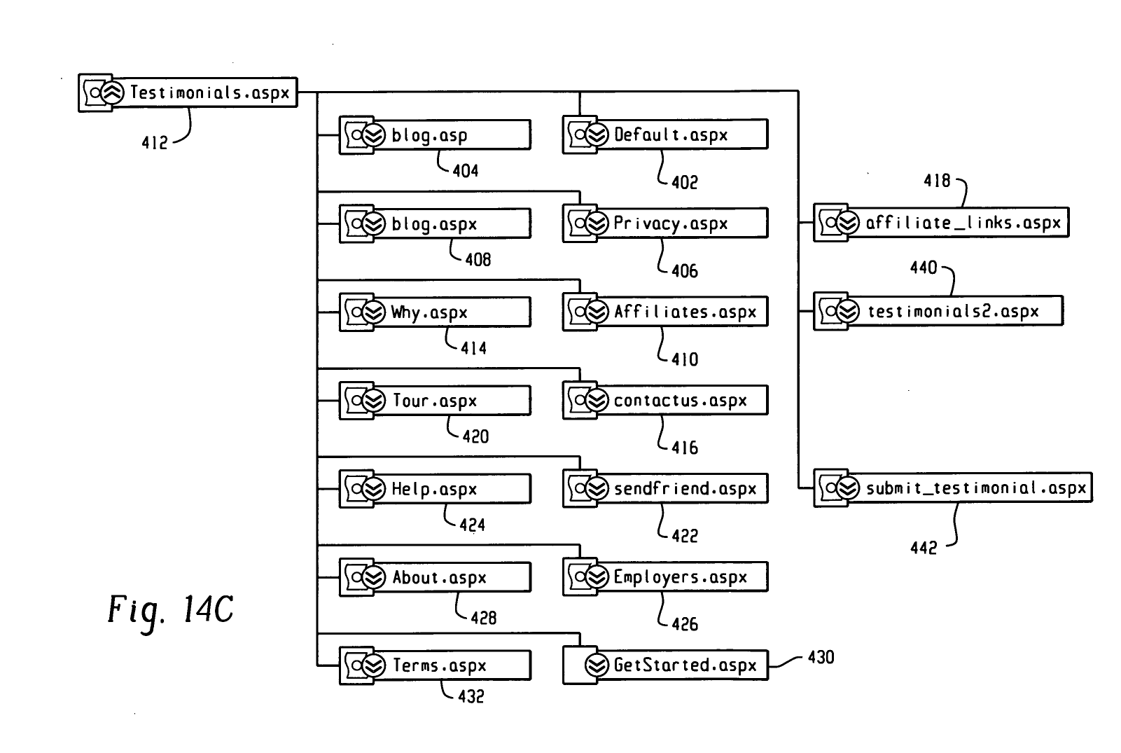

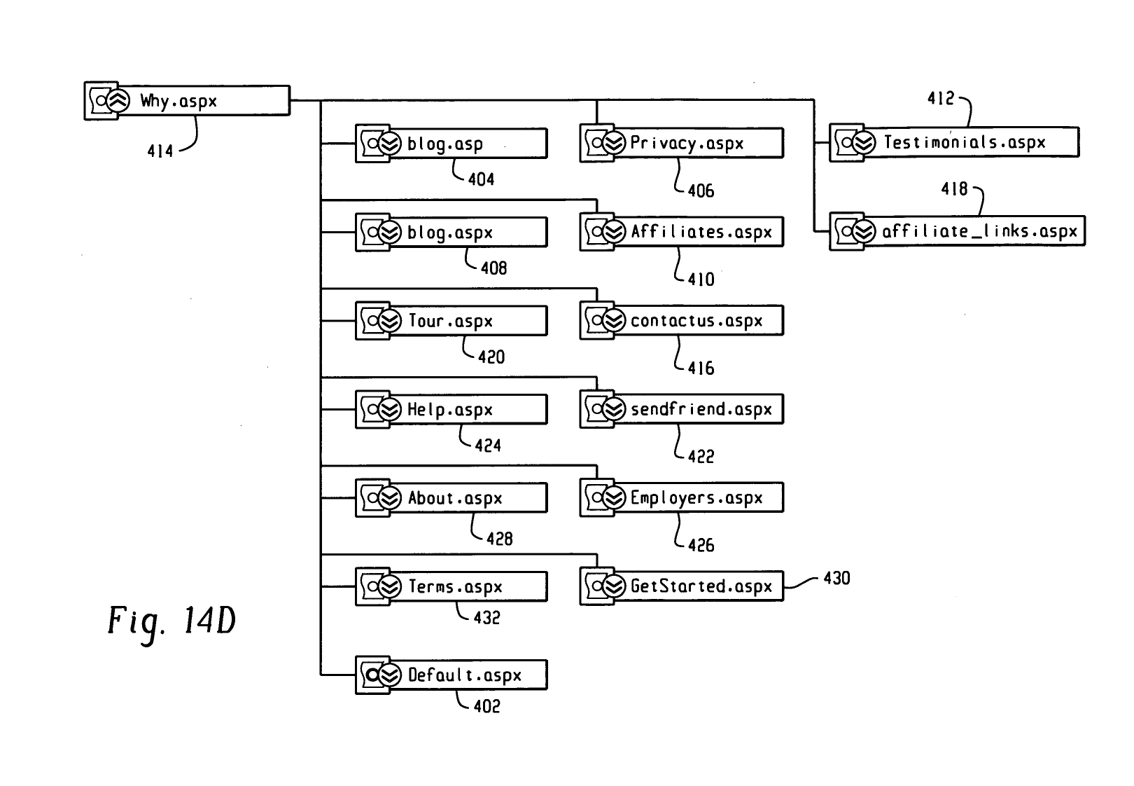

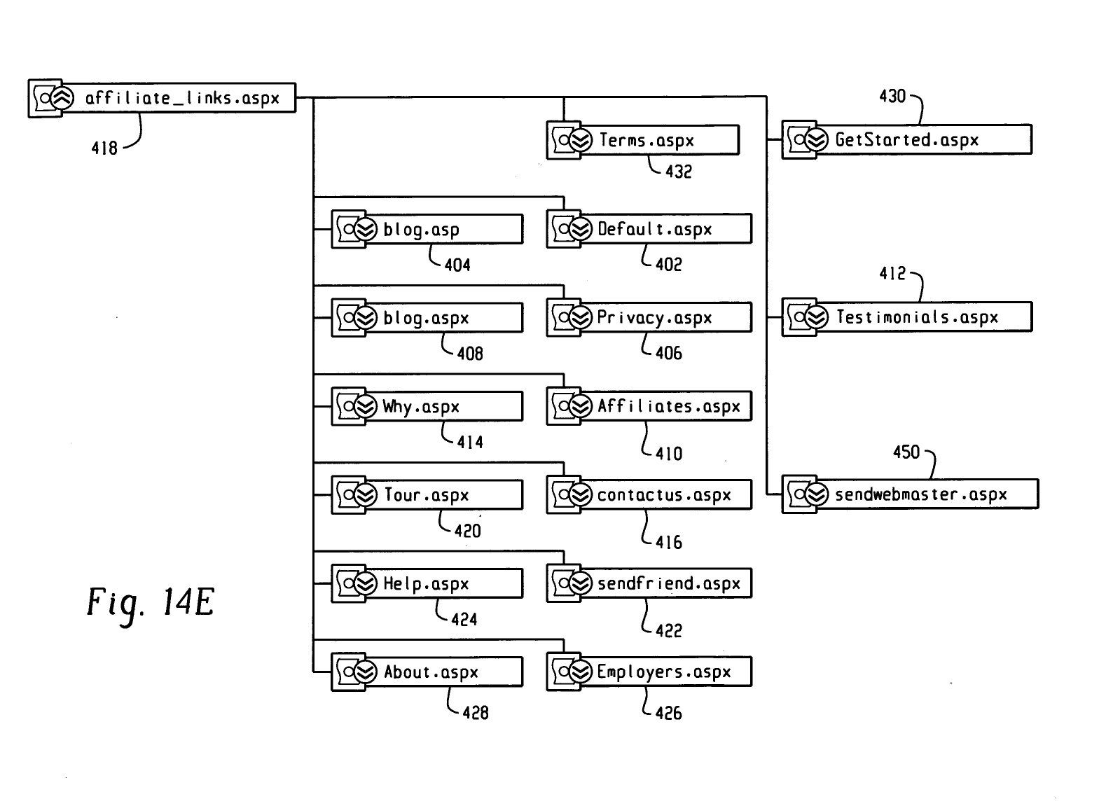

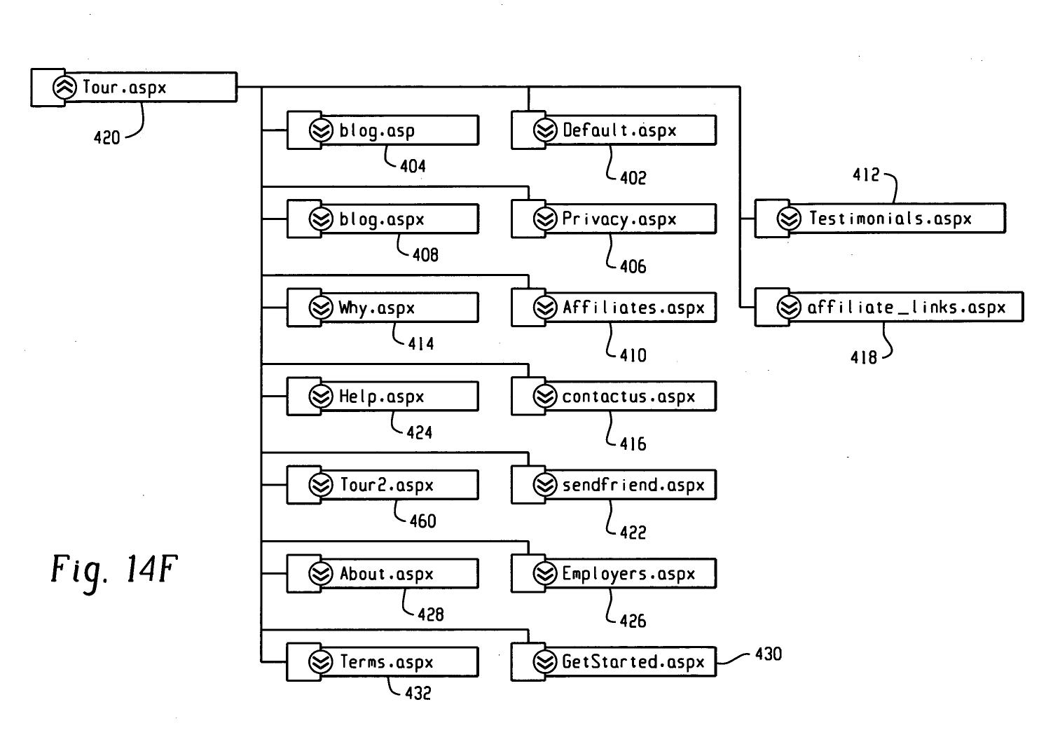

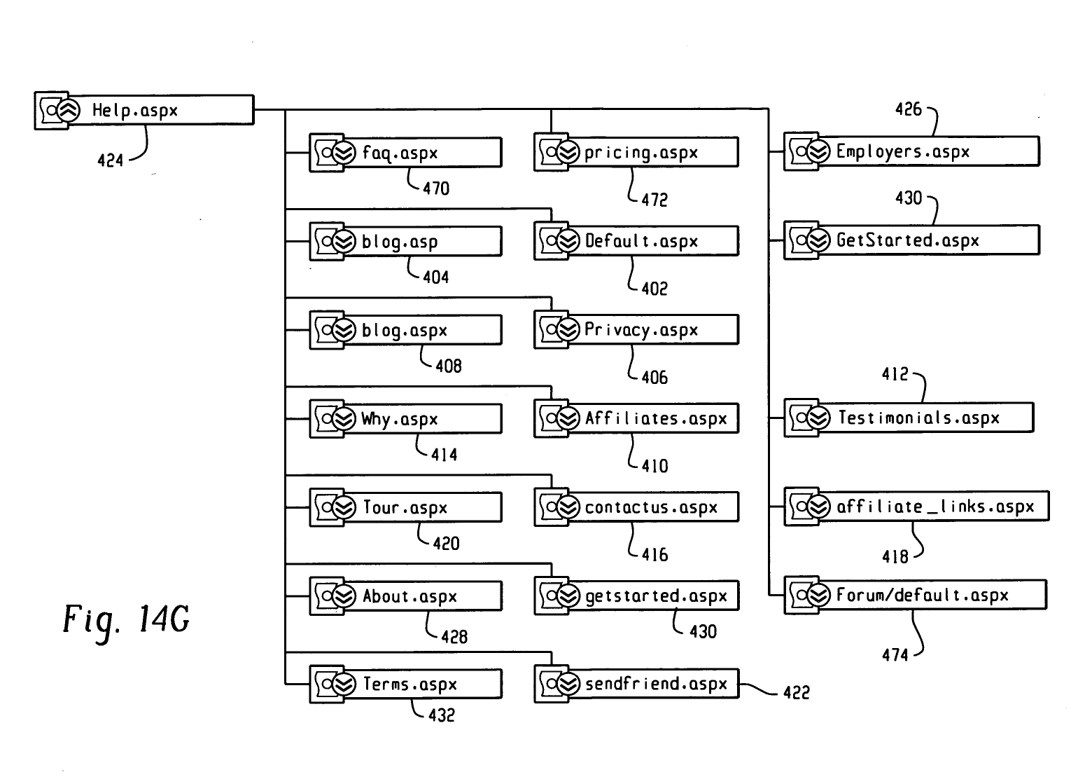

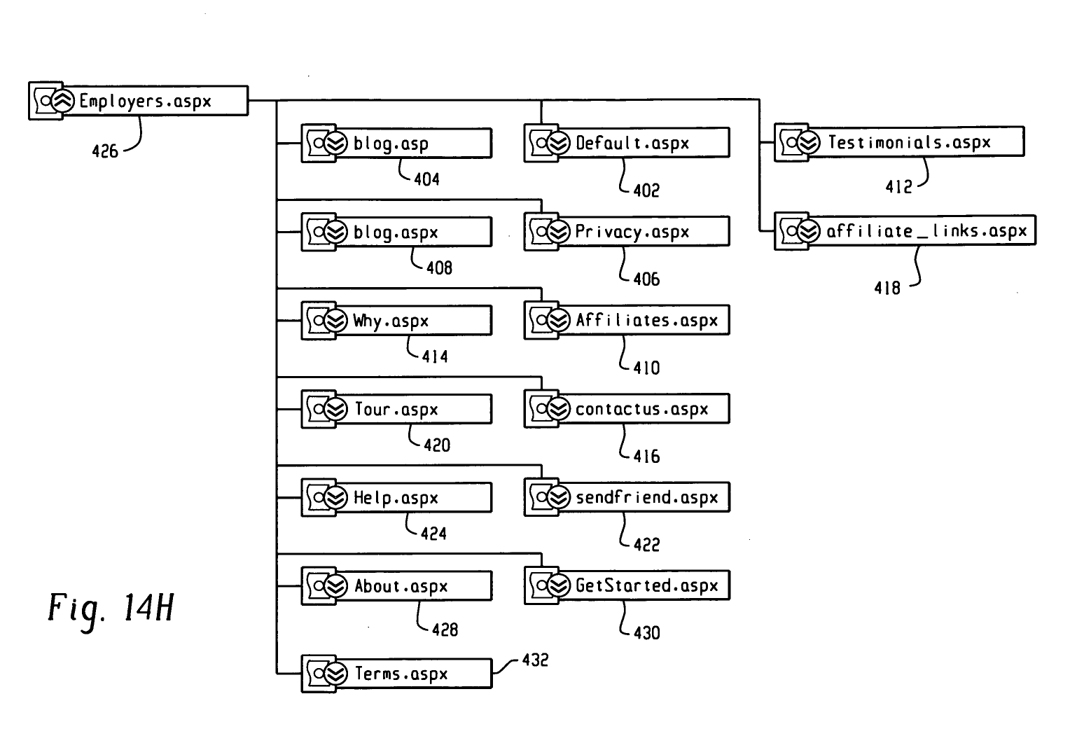

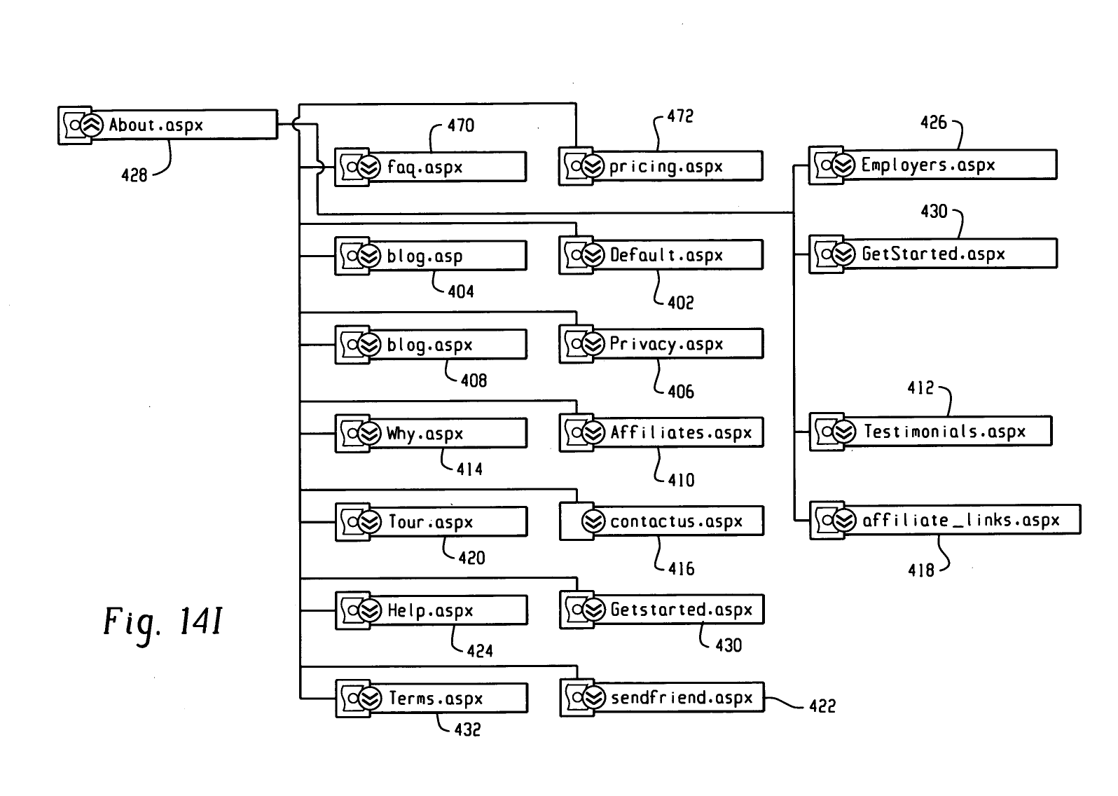

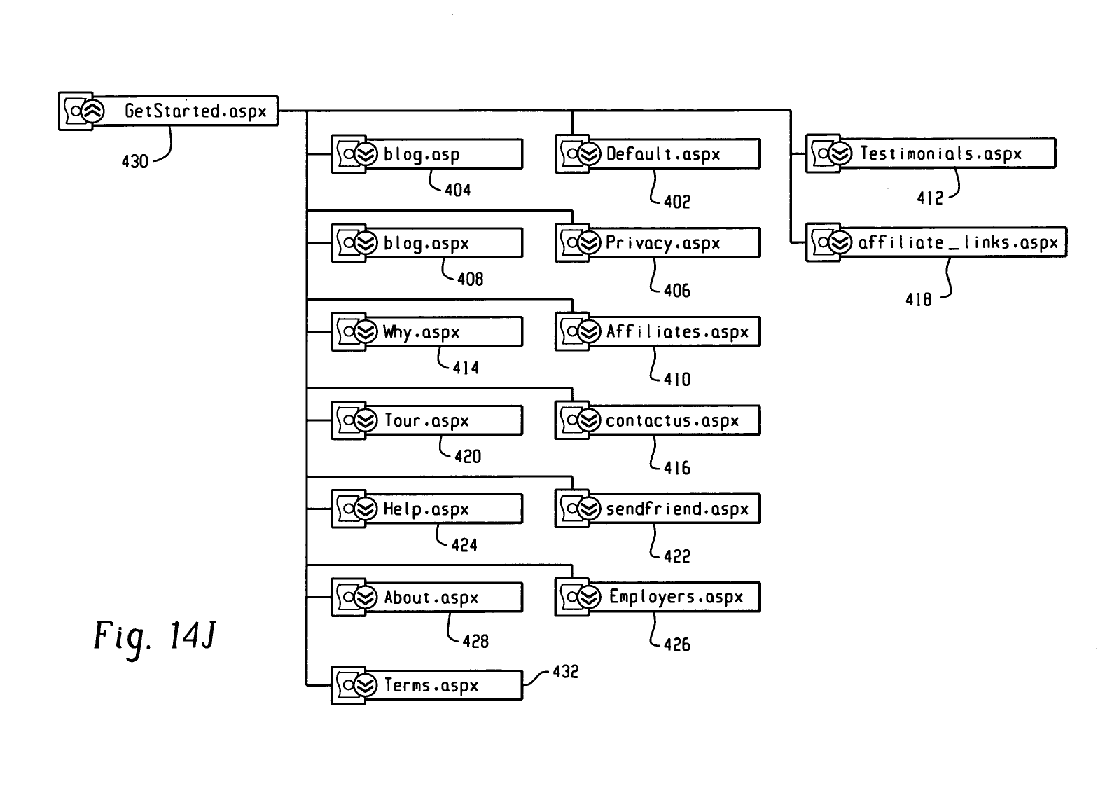

With reference to FIGS. 14-18, now will be described another embodiment of a web based system and method to conduct a job search/contacts search. Specifically, the web based system integrates a job search function, a contacts search function and a campaign function to direct documents, such as resumes and cover letters, to contacts associated with available jobs advertised on the internet by means such as job posting web services and/or company server web postings.

With reference to FIGS. 14A-14J, illustrated are web site maps associated with the outside pages of a web based system according to one exemplary embodiment of this invention. For purposes of this disclosure, “outside pages” refers to web pages accessible to a user whom is not authorized via a member login process to access the “inside pages.”

The web site maps illustrated in FIGS. 14A-14J illustrate the relationships among the various outside web pages of an exemplary web based system.

With reference to FIG. 14A, a user accesses the web based system 400 via a home page or at default.aspx 402. From the default.aspx 402, the user can select to access blog.asp 404, privacy.aspx 406, blog.aspx 408, affiliates.aspx 410, testimonials.aspx 412, why.aspx 414, contactus.aspx 416, affiliate_llinks.aspx 418, tour.aspx 420, sendfriend.aspx 422, help.aspx 424, employers.aspx 426, about.aspx 428, getstarted.aspx 430, and terms.aspx 432.

In operation, the web pages illustrated in FIG. 14A provide a means for the following functions.

Blog.asp 404/blog.aspx 408 web pages provide a means for users to communicate with each other regarding various job hunting and career management topics.

Privacy.aspx 406 web page provides a means for communicating a privacy statement from the web based system operator to a user regarding the collection of personal information.

Affiliates.aspx 410 web page provides a means for recruitment of affiliates and partners associated/linked with the web based system.

Testimonials.aspx 412 web page provides a means for communicating testimonials from past members/subscribers regarding the value of the web based system.

Why.aspx 414 web page provides a means for communicating the benefits and value associated with the web based system.

Contactus.aspx 416 web page provides a means for a user to communicate/contact the web based system operator.

Affiliate_linksxaspx 418 web page provides a means for a user to access web pages associated with affiliates and partners of the web based system operator.

Tour.aspx 420 web page provides a means for a user to view a series of web pages which illustrate and/or describe the operation of the web based system.

Sendfriend.aspx 422 web page provides a means for a user to notify another person, via e-mail, about the web based system.

Help.aspx 424 web page provides a means for a user to access support and other general information related to the web based system. For example, pricing/membership information, frequently asked questions, etc.

Employers.aspx 426 web page provides a means for employers to access services available from the web system operator specifically tailored to employers. For example, a “virtual outplacement service” as a severance benefit for employees.

About.aspx 428 web page provides a means for communicating the history of the web based system and a means for communicating to the user a general description of the web based systems operation.

Getstarted.aspx 430 web page provides a means for a user to become a subscriber/member and access the “inside pages” of the system which provide job hunting and contacts related services.

Terms.aspx 432 webpage provides a means for communicating to a user the terms and conditions of using the web based system.

With reference to FIG. 14B, illustrated is a web site map mapping user accessible web pages from the privacy.aspx 406 web page.

User assessable web pages include blog.asp 404, default.aspx 402, blog.aspx 408, affiliates.aspx 410, testimonials.aspx 412, affiliate_links.aspx 418, why.aspx 414, contactus.aspx 416, tour.aspx 420, sendfriend.aspx 422, help.aspx 424, employers.aspx 426, about.aspx 428, getstarted.aspx 430 and terms.aspx 432.

With reference to FIG. 14C, illustrated is a web site map mapping user accessible web pages from the testimonials.aspx 412 web page. These user accessible web pages include blog.asp 404, default.aspx 402, blog.aspx 408, privacy.aspx 406, affiliate_links.aspx 418, why.aspx 414, affiliates.aspx 410, testimonials2.aspx 440, tour.aspx 420, contactus.aspx 416, help.aspx 424, sendfriend.aspx 422, submit_testimonial.aspx 442, about.aspx 428, employers.aspx 426, terms.aspx 432, and getstarted.aspx 430.

In operation, testimonials2.aspx 440 provides another means for communicating testimonials from past members/subscribers regarding the value of the web based system.

Submit_testimonial.aspx 442 provides a means for a member/subscriber to submit a testimonial.

With reference to FIG. 14D, illustrated is a web site map mapping user accessible web pages from the why.aspx 414 web page.

User accessible web pages include blog.asp 404, privacy.aspx 406, testimonials.aspx 412, blog.aspx 408, affiliates.aspx 410, contactus.aspx 416, help.aspx 424, sendfriend.aspx 422, about.aspx 428, employers.aspx 426, terms.aspx 432, getstarted.aspx 430 and default.aspx 402.

With reference to FIG. 14E, illustrated is a web site map mapping user accessible web pages from the affiliate_links.aspx 418 web page.

User accessible web pages include terms.aspx 432, getstarted.aspx 430, blog.asp 404, default.aspx 402, blog.aspx 408, privacy.aspx 406, testimonials.aspx 412, why.aspx 414, affiliates.aspx 410, tour.aspx 420, contactus.aspx 416, sendwebmaster.aspx 450, help.aspx 424, sendfriend.aspx 422, about.aspx 428 and employers.aspx 426.

Sendwebmaster.aspx 450 web page provides a means for a user to communicate with the web master of the web based system.

With reference to FIG. 14F, illustrated is a web site map mapping user accessible web pages from the tour.aspx 420 web page.

User accessible web pages include blog.asp 404, default.aspx 402, blog.aspx 408, privacy.aspx 406, testimonials.aspx 412, why.aspx 414, affiliates.aspx 410, help.aspx 424, contactus.aspx 416, tour2.aspx 460, sendfriend.aspx 422, about.aspx 428, employers.aspx 426, terms.aspx 432 and getstarted.aspx 430.

Tour2.aspx 460 web page provides another means for a user to tour various web pages which illustrate and/or describe the operation of the web based system.

With reference to FIG. 14G, illustrated is a web site map mapping user accessible web pages from the help.aspx 424 web page.

User accessible web pages. include faq.aspx 470, pricing.aspx 472, employers.aspx 426, blog.asp 404, default.aspx 402, getstarted.aspx 430, blog.aspx 408, privacy.aspx 406, why.aspx 414, affiliates.aspx 410, testimonials.aspx 412, tour.aspx 420, contactus.aspx 416, affiliate_links.aspx 418, about.aspx 428, getstarted.aspx 430, forum/default.aspx 474, terms.aspx 432 and sendfriend.aspx 422.

Faq.aspx 470 web page provides a means for a user to access answers to frequently asked questions about the web based system.

Pricing.aspx 472 web page provides a means for a user to access pricing information related to the web based system.

Forum/default.aspx 474 web page provides a means for a user to access a support forum to report problems and get questions answered.

With reference to FIG. 14H, illustrated is a web site map mapping user accessible web pages from the employers.aspx 426 web page.

User accessible web pages include blog.asp 404, default.aspx 402, testimonials.aspx 412, blog.aspx 408, privacy.aspx 406, affiliate_links.aspx 418, why.aspx 414, affiliates.aspx 410, tour.aspx 420, contactus.aspx 416, help.aspx 424, sendfriend.aspx 422, about.aspx 428, getstarted.aspx 430 and terms.aspx 432.

With reference to FIG. 141, illustrated is a web site map mapping user accessible web pages from the about.aspx 428 web page.

User accessible web pages include faq.aspx 470, pricing.aspx 472, employers.aspx 426, blog.asp 404, default.aspx 402, getstarted.aspx 430, blog.aspx 408, privacy.aspx 406, why.aspx 414, affiliates.aspx 406, testimonials.aspx 412, tour.aspx 420, contactus.aspx 416, affiliate_links.aspx 418, help.aspx 424, getstarted.aspx 430, terms.aspx 432 and sendfriend.aspx 422.

With reference to FIG. 14J, illustrated is a web site map mapping user accessible web pages from getstarted.aspx 430.

User accessible web pages include blog.asp 404, default.aspx 402, testimonials.aspx 412, blog.aspx 408, privacy.aspx 406, affiliate_links.aspx 418, why.aspx 414, affiliates.aspx 410, tour.aspx 420, contactus.aspx 416, help.aspx 424, sendfriend.aspx 422, about.aspx 428, employers.aspx 426 and terms.aspx 432.

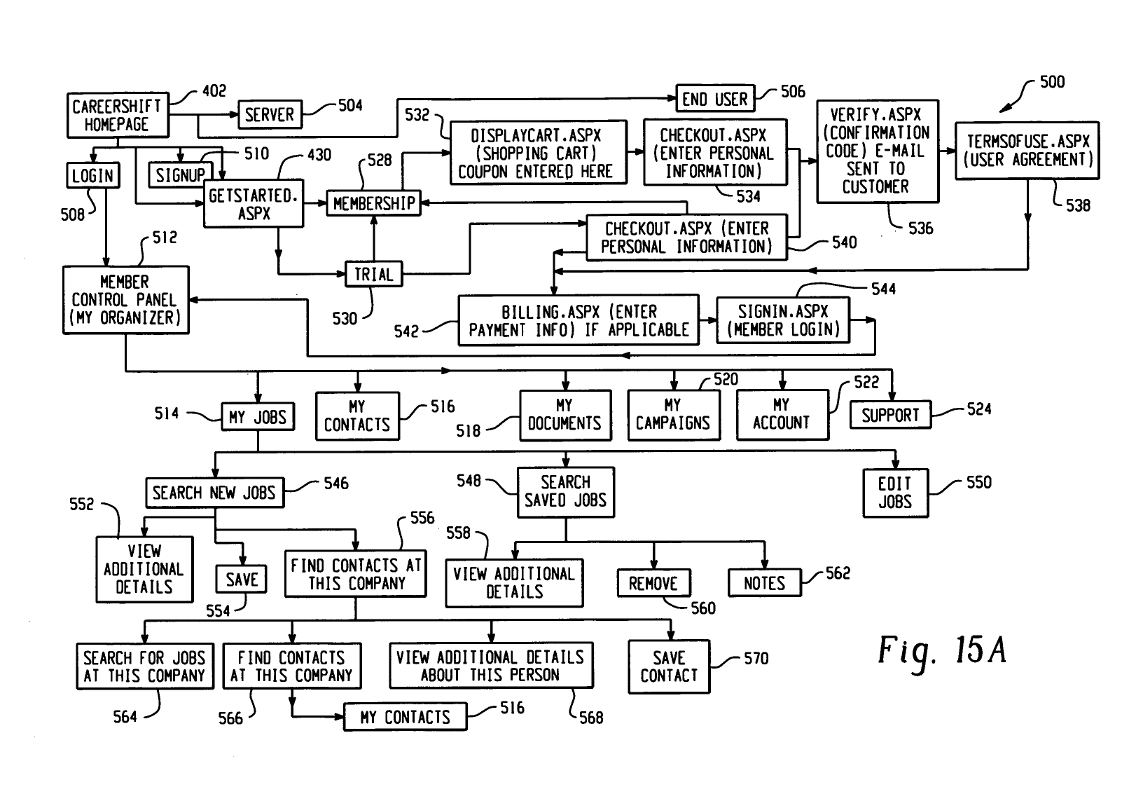

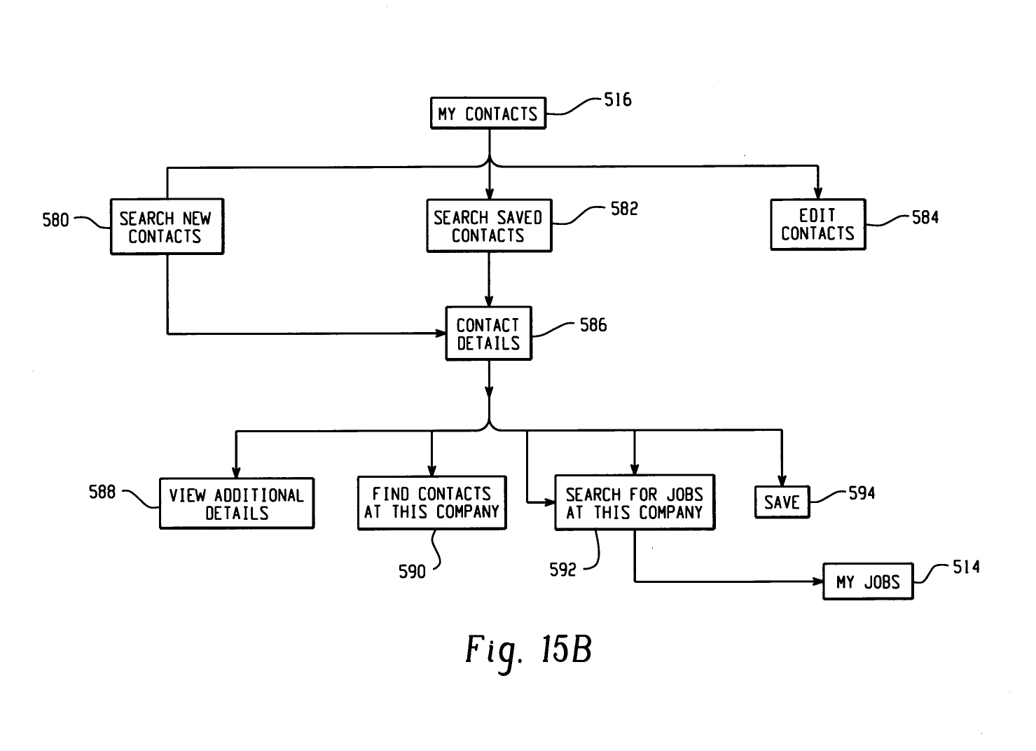

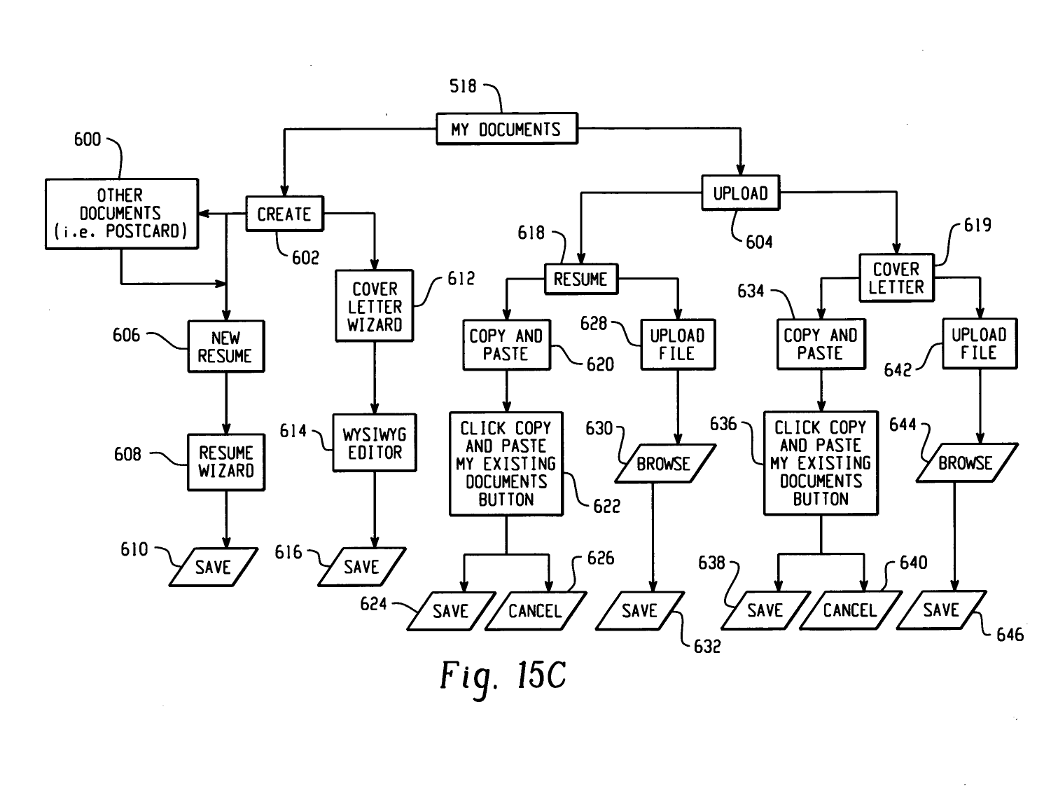

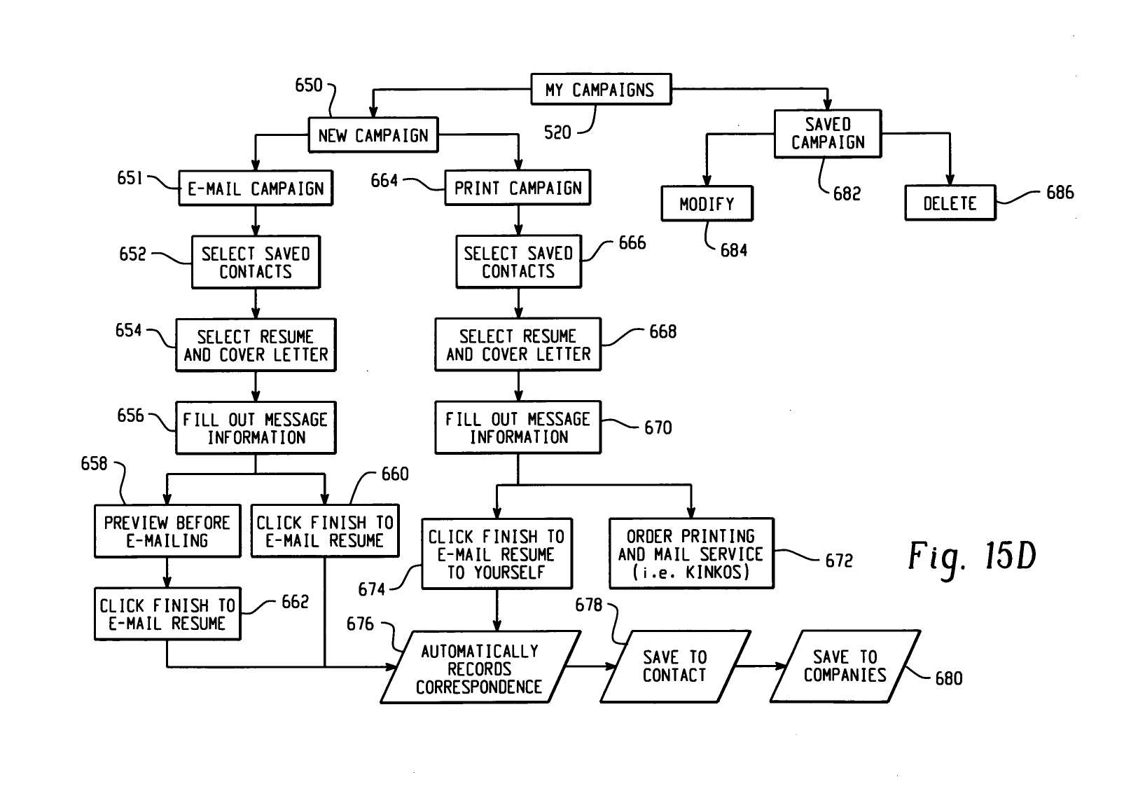

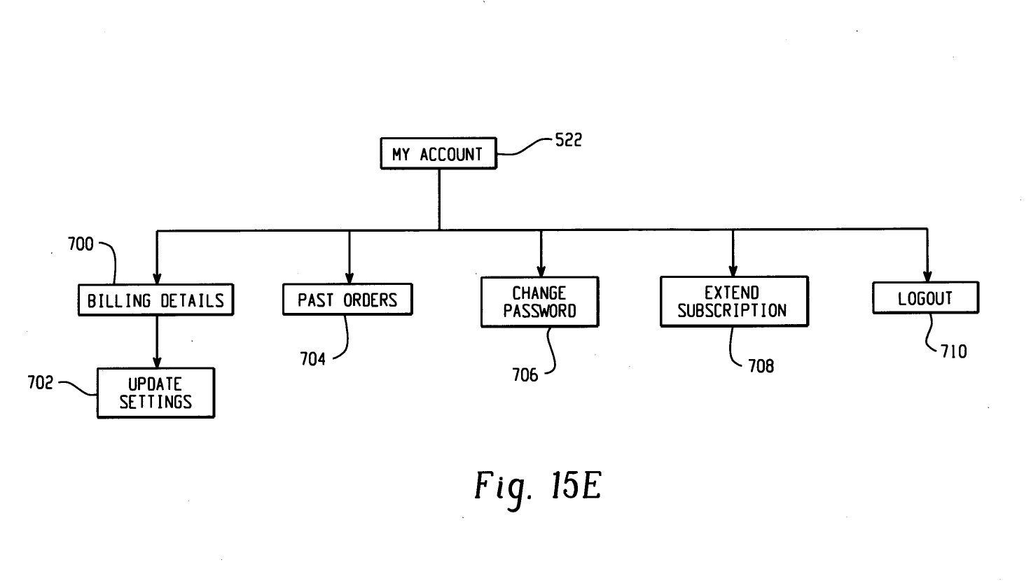

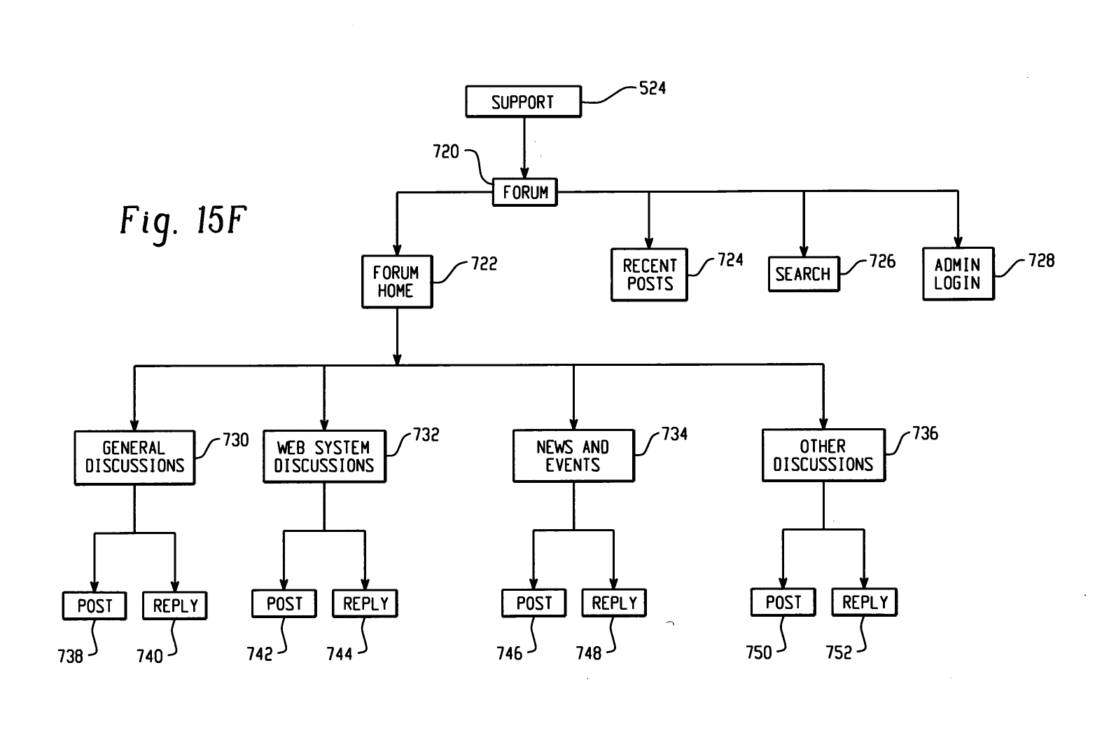

With reference to FIGS. 15A-15F, illustrated are web site maps which provide the functional attributes of the “inside web pages”. The “inside web pages” are accessed via a login which authorizes subscribed users to specific web based services.

With reference to FIG. 15A, a user 506 initially accesses a signup 510 link via the homepage 402 which resides on a server 504. The signup 510 link provides a user with a means to subscribe to the web based system via getstarted.aspx 430.

The getstarted.aspx 430 web page provides access to a membership signup web page 528 which is linked to displaycart.aspx 532, checkout.aspx 534, verify.aspx 536, termsofuse.aspx 538, billing.aspx 542 and signin.aspx 544 sequentially.

Alternatively, a user can access a trial 530 subscription link via getstarted.aspx 430 where the user subsequently is linked to checkout.aspx 540, billing.aspx 542 and signin.aspx 544 sequentially.

The checkout.aspx 540 web page also provides a link for a user to sign up for a regular membership for the web based service via the membership 528 web page.

After a user has acquired the necessary login information, for example a password, etc., the user logs into the system via a login 508 prompt or link. A successful login provides the user/subscriber access to the member control panel 512.

The member control panel 512 web page provides a subscribed user (hereinafter referred to as a subscriber) access to a “my jobs” 514 functional module, “my contacts” 516 functional module, “my documents” 518 functional module, “my campaigns” 520 functional module, “my account” 522 functional module and a “support” 524 module. These functional modules provide a combination of web pages and links to execute subscriber selected functions.

The “my jobs” interface 514 provides a subscriber with access to a “search new jobs” 546 function, a “search saved jobs” 548 function and an “edit jobs” 550 function.

The “search new jobs” 546 function provides a subscriber with an interface which enables a subscriber to search for jobs based on subscriber entered criteria. For example, the criteria can include a key word such as “electrical engineer”, a job type such as “full-time”, a database or website type to search such as “job boards”, a specific company, a job location and/or a job publishing time window such as “within the last 30 days”.

After entering the search criteria, the subscriber executes a job search. The web based system executes the subscriber initiated job search by searching web based job postings, web based job searching engines, company databases, etc. based on the subscriber's inputs. Notably, the web based system may operate as a meta job search engine with regard to providing the necessary data to other web based job searching engines.

After executing the job search, the web based system compiles a list of jobs which match the subscriber selected criteria.

A “save” 554 function provides a means for a subscriber to save the list of matched jobs. In addition, a “view additional details” 552 function provides a means for a subscriber to access more detail associated with the matched job.

A “find contacts at this company” 556 function enables a user to access matched contacts within the matched company. The company contacts information is provided by the web based system, where a company information data base, such as D&B, is accessed via the web. Other functions include searching for jobs at the selected company 564, finding additional contacts at the selected company 566, accessing additional details about a contact 568 and saving contact information 570.

The “search saved jobs” 548 function provides a means for viewing additional details associated with a saved job, removing 560 a saved job from the saved jobs list and/or providing a means for a subscriber to make notes 562 pertaining to a selected saved job.

With reference to FIG. 15B, illustrated is a web site map which indicates the functions available to a subscriber via the “my contacts” 516 web site. These functions include a “search new contacts” 580 function, a “search saved contacts” 582 function and an “edit contacts” 584 function. In addition, the subscriber can access a “contact details” 586 via the “search new contacts” 580 function and/or the “search saved contacts” 582 function.

Functions provided via the “contact details” 586 function include viewing additional details about the contact 588, finding additional contacts at the selected company 590, searching for jobs at the selected company 592 and saving the contact(s) 594.

With reference to FIG. 15C, illustrated is a web site map representing the linkage of multiple web sites and/or functions for a “my documents” 518 module/web site according to one exemplary embodiment of this disclosure.

A subscriber can initially enter “my documents” 518 via the “member control panel” 512 as shown in FIG. 15A. From “my documents” 518, the web based system provides the functions of creating 602 or uploading 604 documents, for example a cover letter, resume, etc. To provide this functionality, the “create” 602 function is integrated with “other documents” 600, “new resume creation” 606 and “cover letter wizard” 612 functions.

In addition, the “new resume” 606 function is interfaced with a “resume wizard” 608 function which includes a menu driven web based system to create a resume and “save” 610 the created resume. The “cover letter wizard” 612 includes a menu driven web based system to create cover letters and is interfaced with a “WYSIWYG editor” 614 function and “save” 616 function.

For copy and pasting within the “my documents” module/web site, a subscriber may select uploading 604 a “resume” 618 and/or “cover letter” 619. To upload a “resume” 618, the “resume” 618 function is interfaced with an “upload file” 628 function to copy and paste text and/or images, a “copy and paste” 620 function is interfaced with a “click copy and paste my existing documents button” 622, a “save” 624 function and a “cancel” 626 function. The “upload file” function is interfaced with a “browse” 630 function and “save function” 632.

To upload a cover letter, the upload “cover letter” 619 function is interfaced with an “upload file” function 642, a “browse” 644 function and a “save” 646 function.

With reference to FIG. 15D, illustrated is a web site map representing the linkage of multiple web sites and/or functions for a “my campaigns” 520 module/web site according to one exemplary embodiment of this disclosure.

A subscriber can initially enter “my campaigns” 520 via the “member control panel” 512 as shown in FIG. 15A. From “my campaigns” 520, the web based system provides the functions of creating a “new campaign” 650 and/or working with “saved campaigns” 682. Features and functions interfaced with “new campaign” 650 include creating an “e-mail campaign” 651 and creating a “print campaign” 664.

The “e-mail campaign” 651 function is interfaced with the functions of “select saved contacts” 652, “select resume and cover letter” 654, “fill out message information” 656, “preview before e-mailing” 658, “click finish to e-mail resume” 660, “automatically record correspondence” 676, “save to contacts” 678 and “save to companies” 680.

The “print campaign” 664 function is interfaced with the functions of “select saved contacts” 666, “select resume and cover letter” 668, “fill out message information” 670, “click finish to e-mail resume to yourself” 674, “order printing and mail service” 672, “automatically record correspondence” 676, “save to contacts” 678 and “save to companies” 680.

To work within “saved campaigns” 682, “modify” 684 and “delete” 686 functions are provided.

With reference to FIG. 15E, illustrated is a web site map representing the linkage of multiple web sites and/or function for a subscriber to manage a “my accounts” 522 module/web site according to one exemplary embodiment of this disclosure.

A subscriber can initially enter “my account” 522 via the “member control panel” 512 as shown in FIG. 15A. From “my account” 522, the web based system provides the functions of “billing details” 700, “update settings” 702 associated with the subscriber, viewing “past orders” 704, “change password” 706, “extend subscription” 708 and “logout” 710.

With reference to FIG. 15F, illustrated is a web site representing the linkage of multiple web sites and/or functions for a “support” 524 module/web site according to one exemplary embodiment of this disclosure.

A subscriber can initially enter the “support” 524 module/web site via the “member control panel” 512 as shown in FIG. 15A. From the “support” 524 module/web site, a subscriber has access to a “forum” 720 which is interfaced with the functions of “forum home” 722, “recent posts” 724, “search” 726, “admin login” 728. Via the “forum home” 722 function, the subscriber has access to multiple discussion forums which include “general discussions” 730, “web system discussions” 732, “news and events” 734 discussions and “other discussions” 736. Each of the discussion forums includes the functions of posting and replying to messages (i.e., “post” 738, 742, 746 and 750; “reply” 740, 744, 748 and 752).

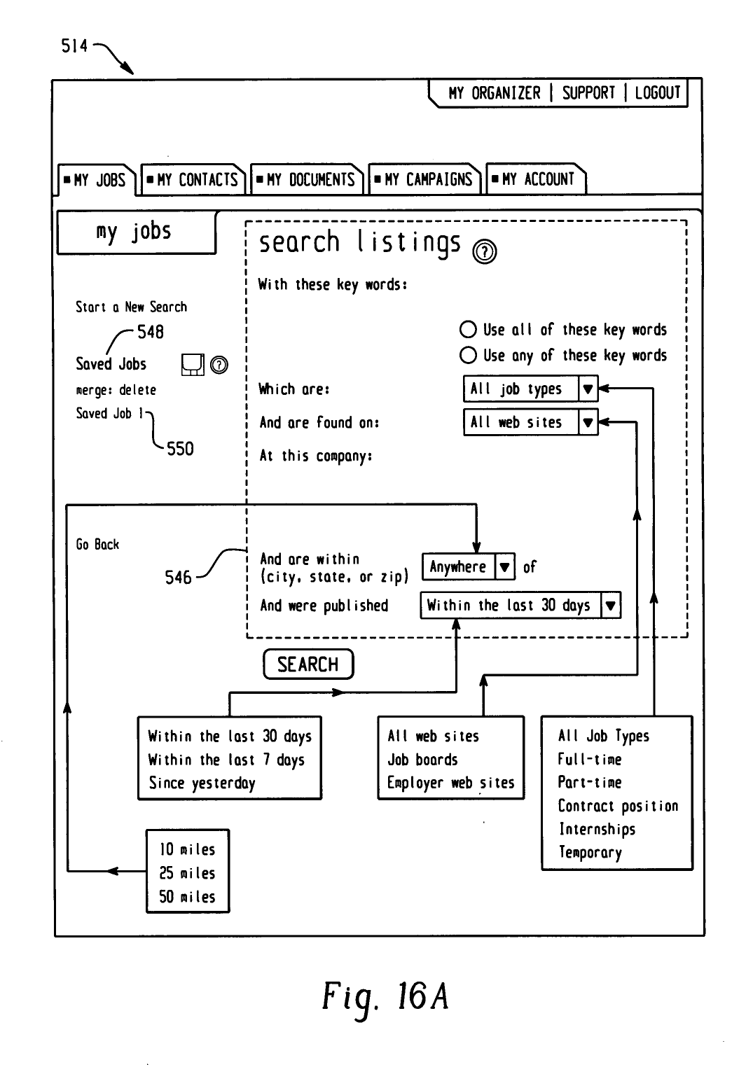

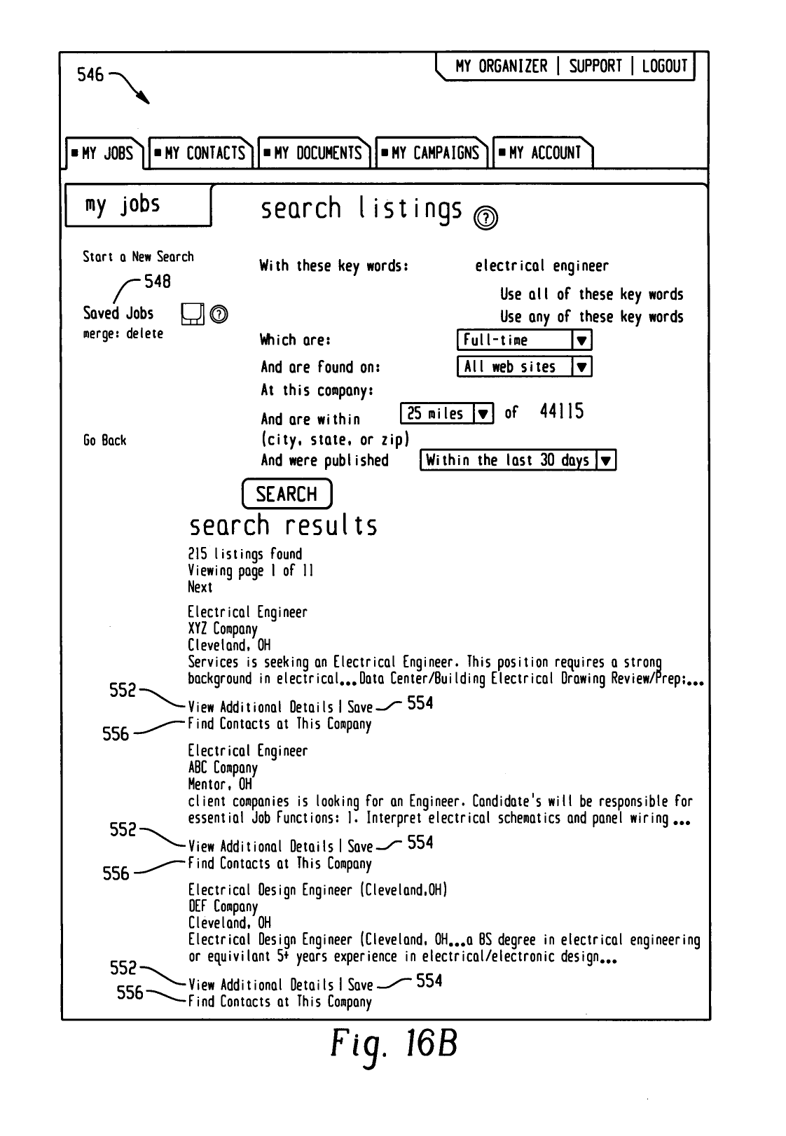

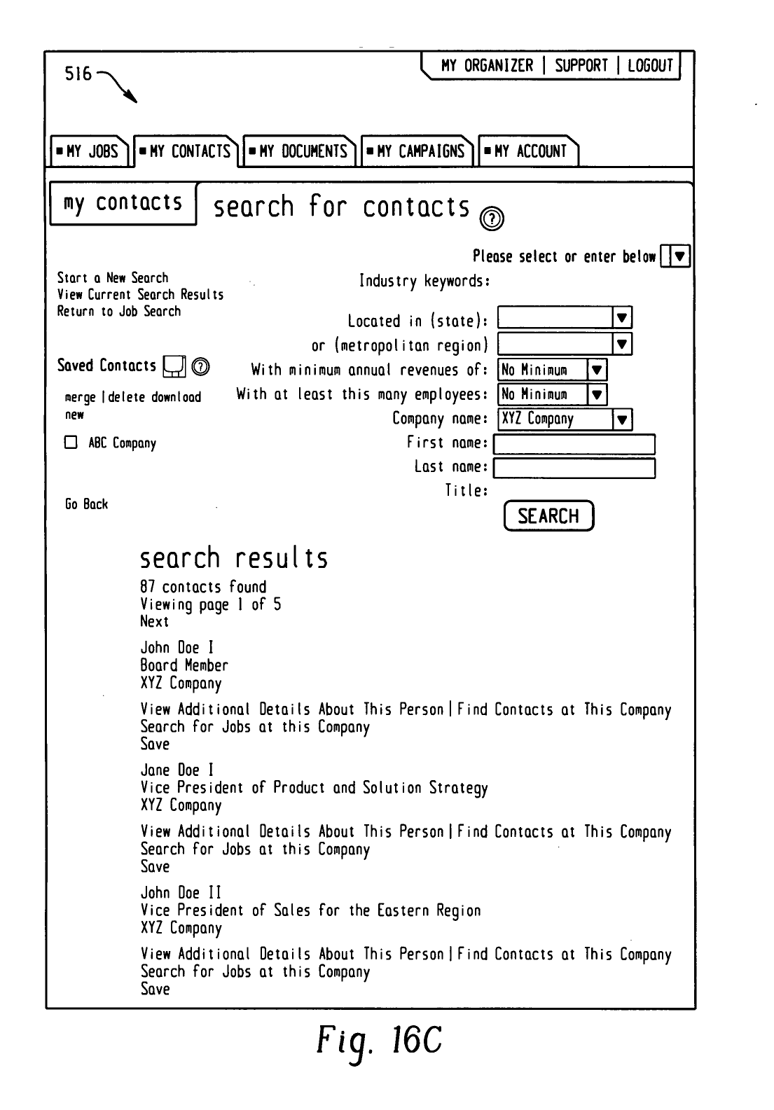

With reference to FIG. 16A, illustrated is a web page associated with a “my jobs” 514 functional module according to one exemplary embodiment of this disclosure. As described with reference to FIG. 15A, the web based system includes a “search new jobs” function 546, a “search saved jobs” 548 function and a means for editing saved jobs 550.

With reference to FIG. 16B, illustrated is one example of a subscriber completed and executed job search according to an exemplary embodiment of this disclosure. The illustrated web page provides a means for executing a job search via the “my jobs” 514 functional module and provides a display of the results associated with the subscriber executed job search.

Notably, the job search criteria associated with FIG. 16B includes a key word “Electrical Engineer”, a job type of “full-time”, a search parameter instructing the web based system to search “all web sites”, a job location limit of “25 miles” of zip code “44115”, and a search parameter instructing the web based system to retrieve only web based job postings initially published within the “last 30 days”.

With continuing reference to FIG. 16B, the search results are displayed after execution of the job search. FIG. 16B illustrates examples of three electrical engineering web based job postings retrieved by the web based system. Additional details 552 of a particular job can be retrieved by the subscriber and particular job postings can be saved 554 in a “saved jobs” 548 directory.

To provide a subscriber with company contact information associated with a particular job search result, a “find contacts at this company” 556 function is provided for each job posting result.

In operation, a subscriber selects or mouse clicks “find contacts at this company” 556 to retrieve further company contact information associated with a particular job posting, for example XYZ company. To access and retrieve this contact information, the web based system interfaces with a company information database or service such as Dunn & Bradstreet and retrieves company contact information, such as names, respective titles, respective departments, telephone numbers, e-mail addresses, etc.

FIG. 16C illustrates one web page screen associated with a subscriber initiated search for contacts within XYZ Company. Notably, to execute the “find contacts at this company” 566 function, the “my jobs” module accesses “my contacts” functional module 516.

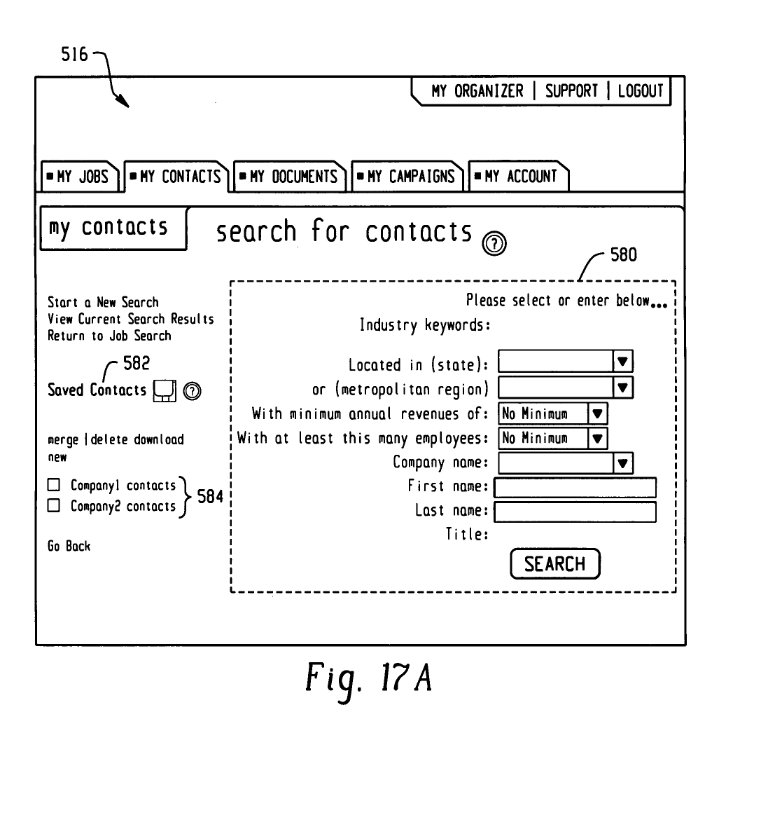

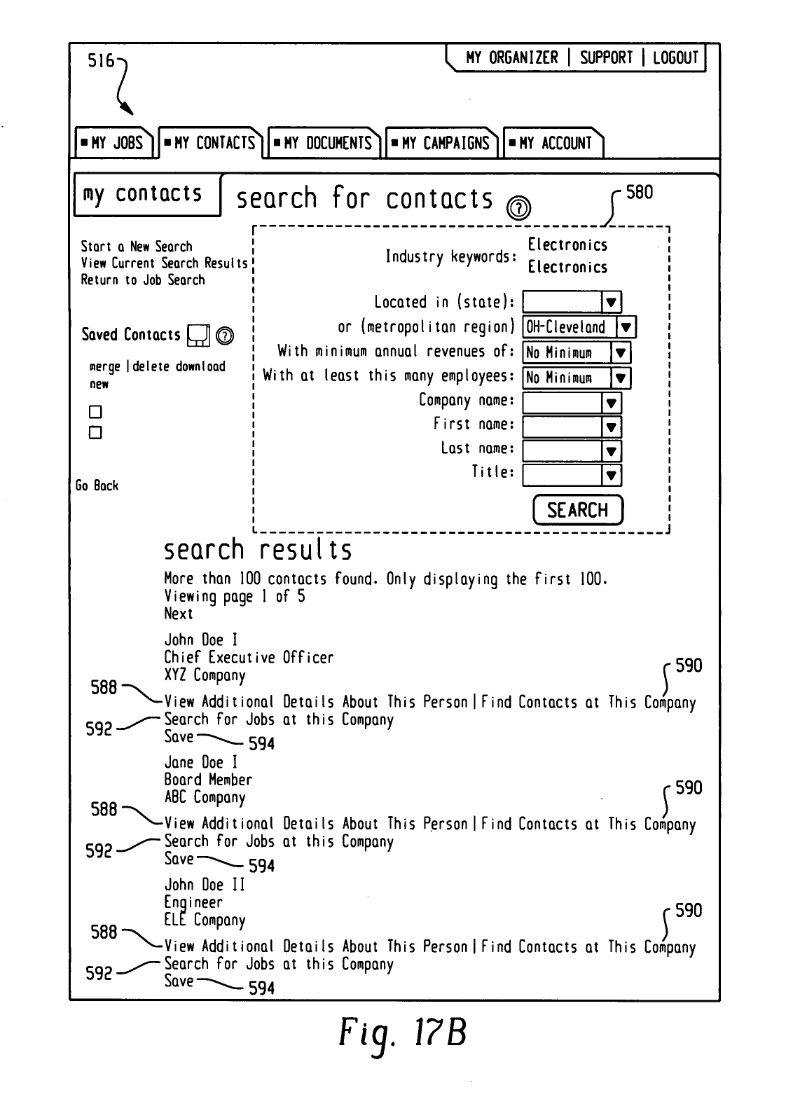

With reference to FIG. 17A, illustrated is a web page screen associated with “my contacts” 516 functional module according to one exemplary embodiment of this disclosure. As discussed with reference to FIG. 15A, the “my contacts” 516 functional module may be accessed via the “member control panel” 512 and/or via the “find contacts at this company” 556 link incorporated into the “my jobs” 514 functional module discussed with reference to FIG. 15A, and FIGS. 16A-16C.

Notably, a subscriber may access the “my contacts” 516 functional module independently of a job search executed by the “my jobs” 514 functional module.

In operation, via the “my contacts” 516 module, the web based system provides a subscriber with a web based screen as illustrated in FIG. 17A to research and access contacts associated with specific subscriber entered criteria. This criteria includes, but is not limited to, industry key words such as accounting, finance, advertising, agriculture, airline/aviation, architecture-building, art/photography/journalism, automotive/motor vehicles/parts, banking/financial services, biotechnology, broadcasting/radio/tv/media, building materials, chemical, construction, charitable/not for profit, computer hardware, computer software, consulting, consumer products, credit-loan-collections, defense/aerospace, education/college, electronics, employment/recruiting/staffing, energy/utilities/gas/electric, entertainment, environmental, exercise/fitness, fashion/apparel/textile, food, funeral-cemetery, government/civil service, etc.

Additional contacts search criteria includes contacts located in a specific geographical area such as a state or metropolitan region, contacts associated with companies that have a minimum annual revenue, for example 5, 10, 25, 50, 100, 250 or 500 million dollars, contacts associated with a company with at least a minimum number of employees, for example 5, 10, 20, 50, 100, 250, 500, 1000, 5000 or 10,000 employees, contacts associated with a specific company, contacts with a specific first and/or last name and contacts with a specific title.

FIG. 17B illustrates a web screen displaying a web based contacts search according to one exemplary embodiment of this disclosure. The illustrated contacts search provides contacts within companies associated with electronics and within the Cleveland, Ohio metropolitan region. Three of the results displayed include John Doe I, Chief Executive Officer of XYZ Company, Jane Doe I, Board Member of ABC Company and John Doe II, Engineer at ELE Company. Provided with each contact are links for a subscriber to “view additional details about this person” 588, “find contacts at this company” 590, and “search for jobs at this company”. In addition, a subscriber can save selected contacts via a “save” 594 function.

Notably, a subscriber can search for contacts via the “my contacts” 516 functional module and subsequently search for available jobs/job posting associated with a resulting contacts company.

Described heretofore with reference to FIGS. 15A-15F, FIGS. 16A-16C and FIGS. 17A-17B is a web based system and method of operating a web based system to search for web accessible job postings based on specific search criteria, retrieving company contacts associated with available jobs determined by the web based job search, searching for contacts/companies based on specific search criteria and accessing available job postings based on the contacts/companies search, and executing an e-mail or print campaign which e-mails or mails resumes and/or cover letters to a contacts list generated by “my jobs” 514 functional module and/or “my contacts” 516 functional module.

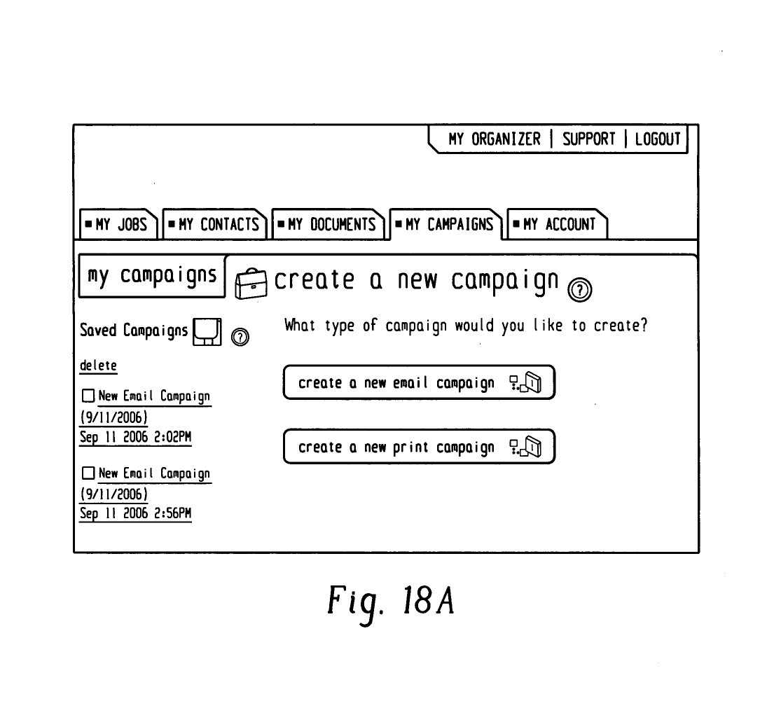

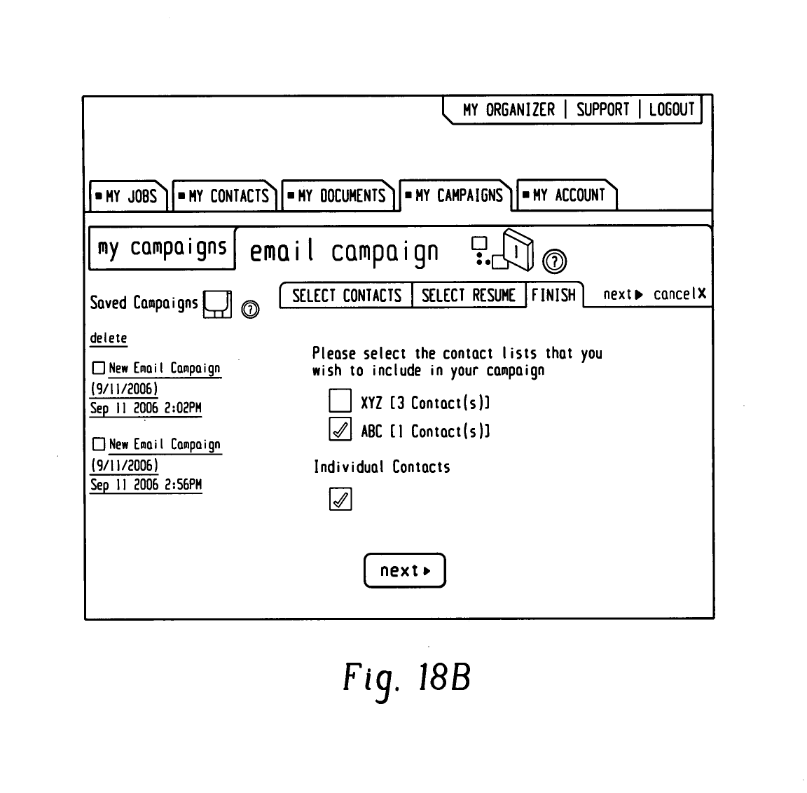

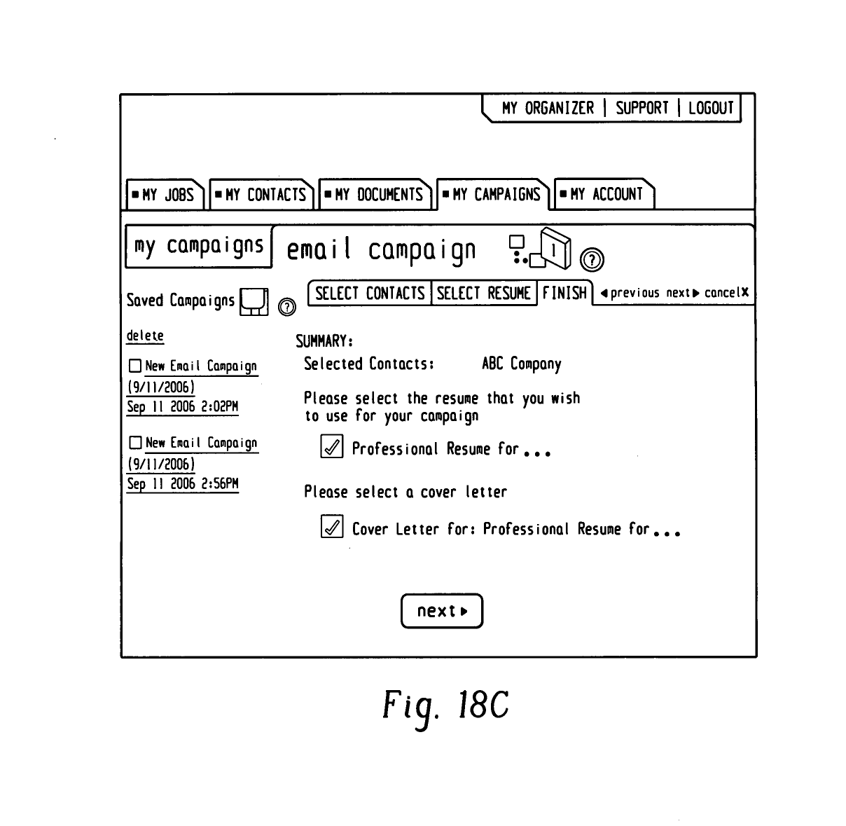

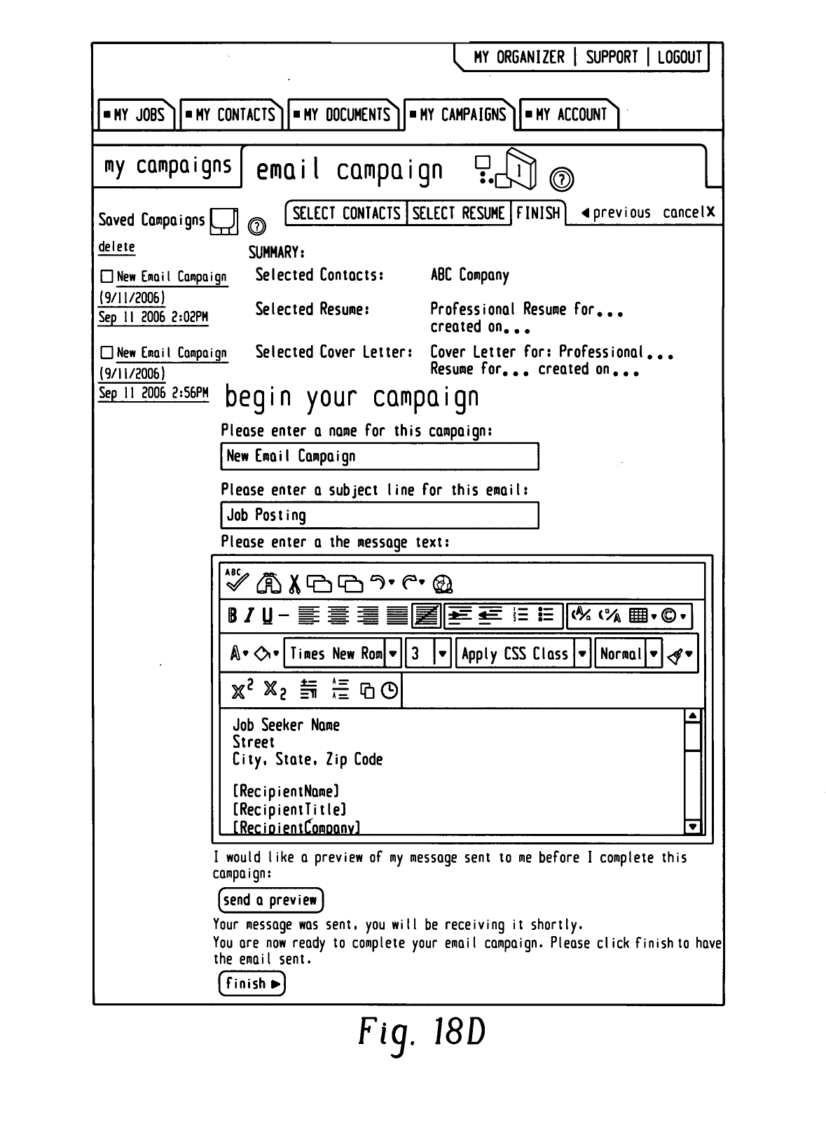

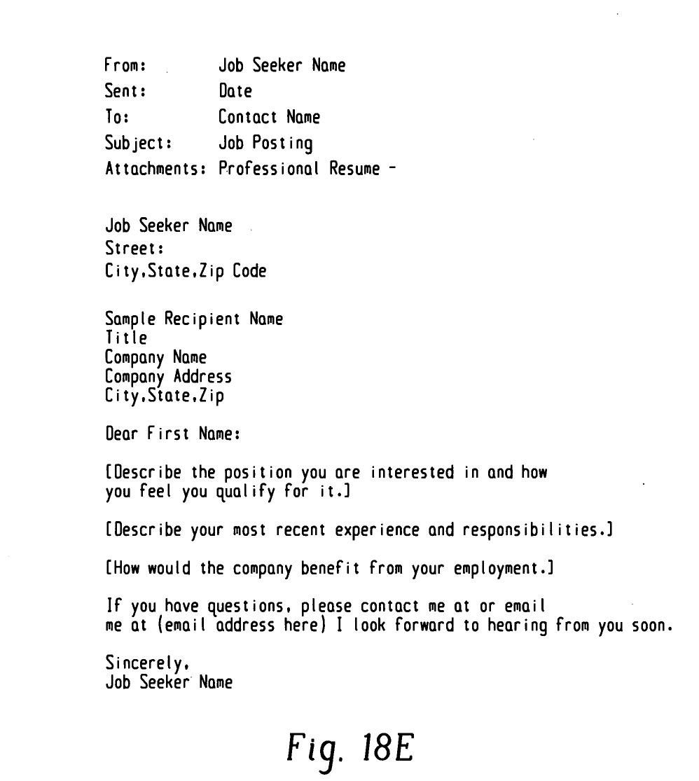

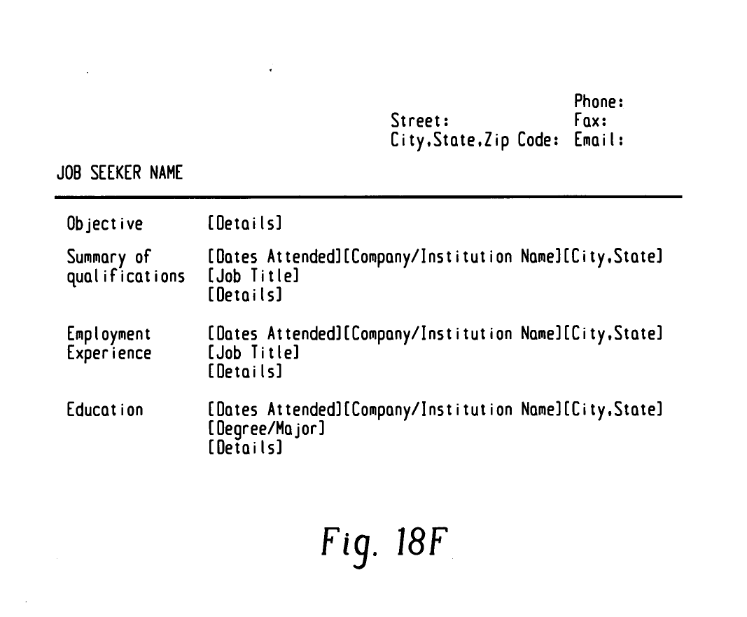

Notably, the e-mail and/or print campaign may include resumes and/or cover letters generated by a resume and/or cover letter generation functional module as described with reference to FIGS. 1-13 and further illustrated in FIGS. 18A-18F. Alternatively, resumes and/or cover letters may be generated by other means and uploaded to the web based system for further processing.

The invention has been described with reference to the preferred embodiments. Obviously, modifications and alterations will occur to others upon reading and understanding the preceding detailed description. It is intended that the invention be construed as including all such modifications and alterations.

1. A method of operating a web based system to compile a list of available jobs comprising:
generating a job search criteria input web page, wherein a user enters one or more job search criteria;
executing a web based job search based on the user entered job search criteria, wherein the web based system searches one or more web sites which post available jobs, and/or provides job search criteria to one or more web search engines which search the web for available jobs;
generating a job search results web page which displays a list of available jobs which satisfy the said user entered job search criteria; and
executing a search for company contact information associated with one or more of the said list of available jobs.

2. The method of operating a web based system according to claim 1, further comprising:
providing a first user selectable link associated with the job search results web page, wherein the first user selectable link initiates a search for company contact information associated with one or more of the said list of available jobs.

3. The method of operating a web based system according to claim 2, further comprising:
generating a company contacts search results web page for one or more of the said list of available jobs, wherein the company contacts search results web page provides a second user selectable link associated with one or more of the said company contacts search results, and the second user selectable link initiates a search for available jobs at one or more of the companies listed within the said company contacts search results.

4. The method of operating a web based system according to claim 3, wherein the company contacts search results page lists one or more of a contact name, contact title, and contact department associated with each contact.

5. A web based system to compile a list of available jobs comprising:
a server configured to perform the following:
(a) generate a job search criteria input web page, wherein the job search criteria input web page is configured to accept one or more job search criteria entered by a user;
(b) execute a web based job search based on the user entered job search criteria, wherein the web based system searches one or more web sites which post available jobs and/or provides one or more job search criteria to one or more web search engines which search the web for available jobs;
(c) generate a job search results web page which displays a list of available jobs which satisfy the said user entered job search criteria; and
(d) execute a search for company contact information associated with one or more of the said list of available jobs.

6. The web based system according to claim 5, the server configured to provide a first user selectable link associated with the job search results web page, wherein the user selectable link initiates the execution of the search for company contact information associated with one or more of the said list of available jobs.

7. The web based system according to claim 5, the server configured to generate a company contacts search results page for one or more of the said list of available jobs, wherein the company contacts search results web page provides a second user selectable link associated with one or more of the said company contacts search results, and the second user selectable link initiates a search for available jobs at one or more of the companies listed within the said company contacts search results.

8. A method of operating a web based system to compile a list of available jobs comprising:
generating a company contacts search criteria input web page, wherein a user enters one or more contacts search criteria;
executing a web based company contacts search based on the user entered company contacts search criteria, wherein the web based system searches one or more web accessible databases for company contact information;
generating a company contacts search results web page which lists company contacts which satisfy the said user entered company contacts search criteria; and
executing a search for available jobs at the companies associated with one or more of the said list of company contacts.

9. The method of operating a web based system according to claim 8, further comprising:
providing a first user selectable link associated with the company contacts results web page, wherein the first user selectable link initiates the execution of the search for available jobs at the companies associated with one or more of the said list of company contacts.

10. The method of operating a web based system according to claim 9, further comprising:
generating an available jobs results web page which lists available jobs for one or more companies associated with the said list of company contacts, wherein the available jobs results web page provides a second user selectable link associated with one or more of the said available jobs and the second user selectable link initiates a search for company contacts associated with one or more available jobs listed within the said available job results web page.

11. A web based system to compile a list of available jobs comprising:
a server configured to perform the following:
(a) generate a company contacts search criteria input web page, wherein a user enters one or more contacts search criteria;
(b) execute a web based company contacts search based on the user entered company contacts search criteria, wherein the web based system searches one or more web accessible databases for company contact information;
(c) generate a company contacts search results web page which lists company contacts which satisfy the said user entered company contacts search criteria; and
(d) execute a search for available jobs at the companies associated with one or more of the said list of company contacts.

12. A web based system according to claim 11, the server configured to provide a first user selectable link associated with the company contacts web page, wherein the first user selectable link initiates the execution of the search for available jobs at the companies associated with one or more of the said list of company contacts.

13. A web based system according to claim 12 the server configured to generate an available jobs results web page which lists available jobs for one or more companies associated with the said list of company contacts, wherein the available jobs results web page provides a second user selectable link associated with one or more of the said available jobs and the second user selectable link initiates a search for company contacts associated with one or more available jobs listed within the said available jobs listed within the said available jobs results web page.

14. A method of operating a web based system comprising:
executing a job campaign process, wherein the job campaign process delivers a subscriber's selected documents to selected contacts within a company or organization.

15. The method of operating a web based system according to claim 14 further comprising delivering a subscriber's selected resumes, cover letters and/or business cards to the selected contacts within a company or organization.

16. The method of operating a web based system according to claim 14, wherein the job campaign process delivers the selected documents to the selected contacts by way of e-mail.

17. The method of operating a web based system according to claim 14, wherein the job campaign process delivers the selected documents to the selected contacts by way of a direct mail service.

18. The method of operating a web based system according to claim 14, further comprising:
prior to executing the job campaign process, executing a company contacts search process based on user selected search criteria, the company contacts search process creating a company contacts search results list,
wherein the job campaign process and company contacts search process are integrated and the said selected contacts comprises the company contacts search results list.

19. The method of operating a web based system according to claim 14, further comprising:
prior to executing the job campaign process, executing a document creation process to produce one or more documents for delivery to one or more company contacts,
wherein the job campaign process and document creation process are integrated and the said selected documents comprises the said one or more documents for delivery to one or more company contacts.

20. The method of operating a web based system according to claim 14, further comprising:
prior to executing the job campaign process, executing a company contacts search process based on user selected search criteria, the company contacts search process creating a company contacts search results list; and
prior to executing the job campaign process, executing a documents creation process to produce one or more documents for delivery to one or more company contacts,
wherein the job campaign process, company contacts search process and document creation process are integrated and the said selected contacts comprises the company contacts search results list and the said selected documents comprises the said one or more company contacts.

21. The method of operating a web based system according to claim 14, further comprising:
prior to executing the job campaign process, executing a jobs search process based on user selected search criteria to produce a jobs search results list,
wherein the job campaign process and job search process are integrated and the said selected contacts comprise contacts associated with the jobs search results list.

22. The method of operating a web based system according to claim 14, further comprising:
prior to executing the job campaign process, executing a job search process based on user selected search criteria to produce a jobs search results list; and
executing a company contacts search process based on user selected search criteria and the jobs search results list, the company contacts search process creating a company contacts search results list,
wherein the job campaign process, the job search process and the company contacts search process are integrated and the said selected contacts comprises the company contacts search results list.

23. The method of operating a web based system according to claim 14, further comprising:
prior to executing the job campaign process, executing a job search process based on user selected search criteria to produce a job search results list; and
executing a documents creation process to produce one or more documents for delivery to one or more company contacts,
wherein the job campaign process, the job search process and documents creation process are integrated and the said selected documents comprises the said one or more documents for delivery to one or more company contacts and the said selected contacts are associated with the said job search results list.

24. The method of operating a web based system according to claim 14, further comprising:
prior to executing the job campaign process, executing a job search process based on user selected search criteria to produce a job search results list;
executing a company contacts search process based on user selected search criteria and the jobs search results list, the company contacts search process creating a company contacts search results list;
executing a documents creation process to produce one or more documents for delivery to one or more company contacts,
wherein the job campaign process, the job search process, the company contacts search process and the documents creation process are integrated and the said selected contacts comprises the said company contacts search results list and the said selected documents comprises the said one or more documents for delivery to one or more company contacts.

25. The method of operating a web based system according to claim 24, wherein the job search process comprises a meta job search process to provide search criteria for one or more accessible job search engines, and the meta job search process compiles a collection of available job positions matching the specific criteria.

26. The method of operating a web based system according to claim 24, wherein the job search process is executed using sixty-four bit encryption.

27. The method of operating a web based system according to claim 24, further comprising:
delivering a subscribers selected resumes, cover letters and/or business cards to the said selected contacts.

28. The method of operating a web based system according to claim 27, wherein the job campaign process delivers the said selected documents to the selected contacts using one or both of direct mail and e-mail.

29. A web based system comprising:
a means for executing a job campaign process, wherein the job campaign process delivers a subscriber's selected documents to selected contacts within a company or organization.

30. A web based system according to claim 29, further comprising:
a means for executing a company contacts search process based on user selected search criteria, the company contacts search process creating a company contacts search results list,
wherein the job campaign process and company contacts search process are integrated and the said selected contacts comprises the company contacts search results list.

31. A web based system according to claim 29, further comprising:
a means for executing a document creation process to produce one or more documents for delivery to one or more company contacts,
wherein the job campaign process and document creation process are integrated and the said selected documents comprises the said one or more documents for delivery to one or more company contacts.

32. A web based system according to claim 29, further comprising:
a means for executing a company contacts search process based on user selected search criteria, the company contacts search process creating a company contacts search results list; and
a means for executing a document creation process to produce one or more documents for delivery to one or more company contacts,
wherein the job campaign process, company contacts search process and document creation process are integrated and the said selected contacts comprises the company contacts search results list and the said selected documents comprises the said one or more company contacts.

33. A web based system according to claim 29, further comprising:
a means for executing a jobs search process based on user selected search criteria to produce a jobs search results list,
wherein the job campaign process and job search process are integrated and the said selected contacts comprise contacts associated with the jobs search results list.

34. A web based system according to claim 29, further comprising:
a means for executing a job search process based on user selected search criteria to produce a jobs search results list; and
a means for executing a company contacts search process based on user selected search criteria and the jobs search results list, the company contacts search process creating a company contacts search results list,
wherein the job campaign process, the job search process and the company contacts search process are integrated and the said selected contacts comprises the company contacts search results list.

35. A web based system according to claim 29, further comprising:
a means for executing a job search process based on user selected search criteria to produce a job search results list; and
a means for executing a documents creation process to produce one or more documents for delivery to one or more company contacts,
wherein the job campaign process, the job search process and documents creation process are integrated and the said selected documents comprises the said one or more documents for delivery to one or more company contacts and the said selected contacts are associated with the said job search results list.

36. A web based system according to claim 29, further comprising:
a means for executing a job search process based on user selected search criteria to produce a job search results list;
a means for executing a company contacts search process based on user selected search criteria and the jobs search results list, the company contacts search process creating a company contacts search results list;
a means for executing a documents creation process to produce one or more documents for delivery to one or more company contacts,
wherein the job campaign process, the job search process, the company contacts search process and the documents creation process are integrated and the said selected contacts comprises the said company contacts search results list and the said selected documents comprises the said one or more documents for delivery to one or more company contacts.

37. The web based system according to claim 36, wherein the job search process comprises a meta job search process to provide search criteria for one or more accessible job search engines, and the meta job search process compiles a collection of available job positions matching the specific criteria.

38. The web based system according to claim 36, wherein the job search process is executed using sixty-four bit encryption.

39. The web based system according to claim 36, further comprising:
a means for delivering a subscribers selected resumes, cover letters and/or business cards to the said selected contacts.

40. The web based system according to claim 36, wherein the job campaign process is configured to deliver the said selected documents to the selected contacts using one or both of direct mail and e-mail.

41. A method of operating a web based system comprising:
performing a web based job search tailored to specific search criteria selected by a subscriber, wherein a meta job search engine provides search criteria for one or more accessible job search engines, and the meta job search engine compiles a collection of available job positions matching the specific criteria selected by the user.

42. The method of operating a web based system according to claim 41, wherein the web based job search accesses one or more databases comprising available job listings and the web based system compiles a collection of available job positions matching the specific criteria selected by the user.

43. The method of operating a web based system according to claim 42, wherein the specific search criteria includes one or more criteria associated with company type, company name, company size, company sales volume, company industry, and company minority classification and job type, job salary and job location.

44. A web based system to perform a web based job search comprising:
a means for performing a web based job search tailored to specific search criteria selected by a subscriber, wherein a meta job search engine provides search criteria for one or more accessible job search engines, and the meta job search engine compiles a collection of available job positions matching the specific criteria selected by the user.

45. The web based system according to claim 44, wherein the web based job search accesses one or more databases comprising available job listings and the web based system compiles a collection of available job positions matching the specific criteria selected by the user.

46. The web based system according to claim 45, wherein the specific search criteria includes one or more criteria associated with company type, company name, company size, company sales volume, company industry, and company minority classification and job type, job salary and job location.
